(19) United States
(12) Patent Application Publication
(10) Pub. No.: US 2020/0265044 A1
(43) Pub. Date: Aug. 20, 2020

(54) PATH SEARCHING METHOD, STORAGE MEDIUM AND PATH SEARCHING APPARATUS

(71) Applicant: FUJITSU LIMITED, Kawasaki-shi (JP)

(72) Inventors: Yasuo Yamane, Machida (JP); Tetsuyoshi Shiota, Yokohama (JP)

(73) Assignee: FUJITSU LIMITED, Kawasaki-shi (JP)

(21) Appl. No.: 16/789,500

(22) Filed: Feb. 13, 2020

(30) Foreign Application Priority Data
Feb. 15, 2019 (JP) 2019-025655

(51) Int. Cl. G06F 16/2453; G06F 16/22

(52) U.S. Cl. CPC G06F 16/2453; G06F 16/2237

(57) ABSTRACT

A path searching method to be executed by a computer, the path search method includes identifying a starting point and an end point from nodes included in graph data; identifying, by using a limit value for which a value lower than a predetermined number is set, a joint point where a path from the starting point and a path from the end point are jointed; limiting a number of paths to be held in association with each of nodes including the joint point to a number equal to or lower than the limit value and holding a path having a short distance among paths reaching each of the nodes; searching, by using the paths held in association with the nodes, paths whose number is equal to or lower than a higher predetermined number among the paths reaching the joint point; and outputting the paths that have been searched.

### CROSS-REFERENCE TO RELATED APPLICATION

This application is based upon and claims the benefit of priority of the prior Japanese Patent Application No. 2019-25655, filed on Feb. 15, 2019, the entire contents of which are incorporated herein by reference.

### FIELD

The embodiments discussed herein relate to a path searching method, a storage medium and a path searching apparatus.

### BACKGROUND

In various fields including social networking service (SNS), customer relation management, network management, bioengineering, and transportation, an increased number of applications are utilizing network-based data. The term “network-based data” refers to so-called networks such as the Internet, a web and a transportation network, human relations and relations between molecules. The network-based data include vertices and an edge coupling the vertices. A human relation is modeled by defining humans as vertices and a relationship between the humans as an edge.

Such network-based data are mathematically called a graph or graph data. The graph data are analyzed to extract important information for business, management, a study or the like. A method that searches the shortest path between two vertices such as breadth-first search, Dijkstra method and bidirectional search has been widely utilized for the graph data analysis.

FIG. 35 is a diagram for explaining breadth-first search. Breadth-first search is a method that searches the shortest path in an unweighted graph. As illustrated in FIG. 35, according to breadth-first search, vertices linked to a starting point are searched concentrically about the starting point, and the processing ends when an end point appears on a concentric circle,

FIG. 36 is a diagram for explaining Dijkstra method. Dijkstra method is a method that searches the shortest path in a weighted graph. As illustrated in FIG. 36, according to Dijkstra method, adjacent vertices from a starting point are sequentially put into a priority queue, and less weighted vertices are sequentially taken out therefrom. The processing ends when all vertices are taken out.

For example, according to Dijkstra method, a vertex 0 is defined as a starting point, and paths to all vertices adjacent thereto are put into a priority queue (or queue with priority). Next, Dijkstra method takes out the path at the beginning of the priority queue. The path [0,1] taken out here is the shortest path from the vertex 0 to the vertex 1. Next, like the processing performed on the vertex 0, Dijkstra method puts, into a priority queue, paths to all vertices adjacent to the vertex 1 that is the last vertex of the taken path. However, the vertex 0 that has already been followed is excluded. After that, Dijkstra method takes out the path [0,2] at the beginning of the priority queues The path [0,2] taken out here is the shortest path from the vertex 0 to the vertex 2. Dijkstra method executes this processing until the end point is taken out from the priority queue to search the shortest path from the starting point to the end point.

FIG. 37 is a diagram for explaining bidirectional search. As illustrated in FIG. 37, according to bidirectional search, breadth-first search is performed simultaneously in both directions from a starting point and an end point. When the bidirectional paths collide, the paths are combined. The bidirectional search ends when the sum of lengths of paths at the beginning of queues used for the bidirectional search is longer than the shortest path that has been searched up to this point.

In recent years, k paths (hereinafter, which will also be called “k-shortest paths”) from the shortest path to the kth path among paths between two points are searched as a detour search in a transportation network or a computer network communication. For example, a shortest path between a starting point and an end point is acquired. When the shortest path includes p edges, p graphs excluding the edges are considered. The shortest one of the p shortest paths acquired from the graphs is determined as the second shortest path. A similar method thereto is applied to acquire the third and subsequent shortest paths. Related art is disclosed, for example, Japanese Laid-open Patent Publication No. 2017-098593, Japanese Laid-open Patent Publication No. 2010-286978, Japanese Laid-open Patent Publication No. 2016-194908, and E. Filtz, et al, “On finding the k shortest paths in RDF data”, IESD (Intelligent Exploration of Semantic Data), 2016.

### SUMMARY

According to an aspect of the embodiments, a path searching method to be executed by a computer, the path search method includes identifying a starting point and an end point from among a plurality of nodes included in graph data; when a predetermined number of shortest paths are searched from among paths jointing the starting point and the end point, by using a limit value for which a value lower than the predetermined number is set, identifying a joint point where a path from the starting point and a path from the end point are jointed from both of the starting point and the end point; limiting a number of paths to be held in association with each of the plurality of nodes including the joint point to a number equal to or lower than the limit value and holding a path having a short distance from among paths reaching each of the nodes; searching the predetermined number of shortest paths from among the paths reaching the joint point by using the paths held in association with the nodes; and outputting the searched predetermined number of shortest paths.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a searching apparatus according to Embodiment 1;

FIG. 2 is a functional block diagram illustrating a functional configuration of the searching apparatus according to Embodiment 1;

FIG. 3 is a diagram illustrating an example of graph data stored in a graph data DB;

FIG. 4 is a diagram illustrating an example including input graph data to an output result;

FIG. 5 is a flowchart illustrating a flow of processing according to Embodiment 1;

FIGS. 6A to 6C are diagrams for explaining relationships between a vertex v and a starting point and the vertex v and an end point;

FIGS. 7A and 7B are diagrams illustrating a data structure example of a graph according to Embodiment 2;

FIG. 8 is a flowchart illustrating a flow of k-shortest path searching processing according to Embodiment 2;

FIG. 9 is a flowchart illustrating a flow of v extension processing according to Embodiment 2;

FIG. 10 is a flowchart illustrating a flow of processing for adjacent vertices of v according to Embodiment 2;

FIG. 11 is a flowchart illustrating a flow of “is_extended (x, i, path_length. is_v)” that is a function that performs extension determination processing according to Embodiment 2;

FIGS. 12A and 12B are diagrams for explaining a queue state and an initialization state of a specific example according to Embodiment 2;

FIG. 13 is a diagram for explaining adjacent vertex processing at a starting point and an end point;

FIG. 14 is a diagram for explaining a data structure after the adjacent vertex processing at the starting point and the end point;

FIG. 15 is a diagram for explaining adjacent vertex processing at a vertex 1 and a vertex 5;

FIG. 16 is a diagram for explaining data structures after the adjacent vertex processing at the vertex 1 and the vertex 5;

FIG. 17 is a diagram for explaining adjacent vertex processing at a vertex 3 and a vertex 7;

FIG. 18 is a diagram for explaining data structures after the adjacent vertex processing at the vertex 3 and the vertex 7;

FIG. 19 is a diagram for explaining adjacent vertex processing at a vertex 2;

FIG. 20 is a diagram for explaining data structures after the adjacent vertex processing at the vertex 2;

FIG. 21 is a diagram for explaining adjacent vertex processing at a vertex 4;

FIG. 22 is a diagram for explaining data structures after the adjacent vertex processing at the vertex 4;

FIG. 23 is a diagram for explaining adjacent vertex processing at a vertex 5 and a vertex 6;

FIG. 24 is a diagram for explaining data structures after the adjacent vertex processing at the vertex 5 and the vertex 6;

FIG. 25 is a diagram for explaining adjacent vertex processing at the vertex 6 and a vertex 1;

FIG. 26 is a diagram for explaining data structures after the adjacent vertex processing at the vertex 6 and the vertex 1;

FIG. 27 is a diagram for explaining partial shortest paths at joint points on a diagonal line;

FIG. 28 is a flowchart illustrating a flow of optimization processing to be performed on a parameter α according to Embodiment 3;

FIG. 29A and 29B and 29C are a diagram illustrating measurement results of the optimization of the parameter α;

FIG. 30 is a diagram illustrating a relationship between pₘₐₓ (horizontal axis) and maximum time ratio or precision (vertical axis);

FIG. 31 is a diagram for explaining comparison results based on presence of approximation;

FIGS. 32A and 32B are diagrams for explaining a reduction effect by max;

FIG. 33 is a diagram for explaining comparison with extended Dijkstra;

FIG. 34 is a diagram for explaining a hardware configuration example;

FIG. 35 is a diagram for explaining breadth-first search;

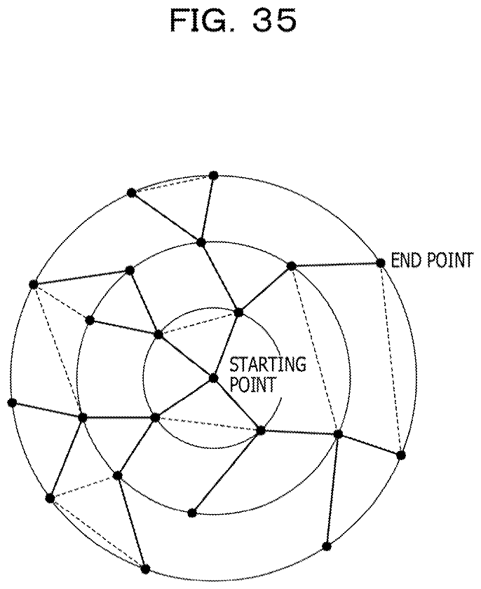

FIG. 36 is a diagram for explaining Dijkstra method; and

FIG. 37 is a diagram for explaining bidirectional search.

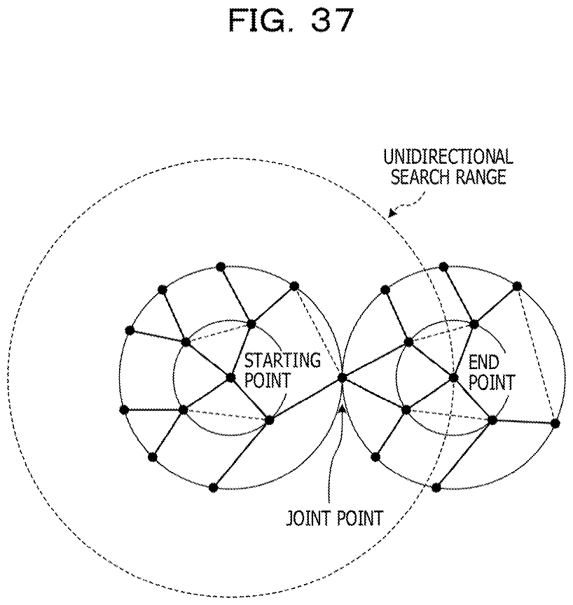

### DESCRIPTION OF EMBODIMENTS

In complex graph data having many vertices, the number of paths from one starting point vertex (node) is enormous. In order to search the k-shortest paths in complex graph data, shortest paths are to be searched with respect to the enormous number of paths passing through each of vertices, resulting in a higher amount of computational complexity and longer search times.

An extension of Dijkstra method for acquiring shortest paths (hereinafter, which will sometimes be called “extended Dijkstra method”) may be considered. For example, the extended Dijkstra method searches a path departing from a starting point and reaching an end point substantially concentrically as in breadth-first search. However, not only the shortest path but also the searched second and subsequent shortest paths are held at vertices of the paths passing therethrough during the search. In this way, the extended Dijkstra method executes a search for the k-shortest paths. However, in the extended Dijkstra method, as the number of vertices increases, the number of paths to be searched at each of the vertices enormously increases, which requires the time for the searching processing. In view of this, it is desirable to reduce the time for searching the shortest path.

Embodiments of a path searching method, a path searching program, a path searching apparatus and data structures of path searches disclosed in the present application will be described in detail below with reference to drawings. The embodiments do not limit the present disclosure. The embodiments may be combined with each other as appropriate when there is no contradiction.

### Embodiment 1

### Description of Searching Apparatus

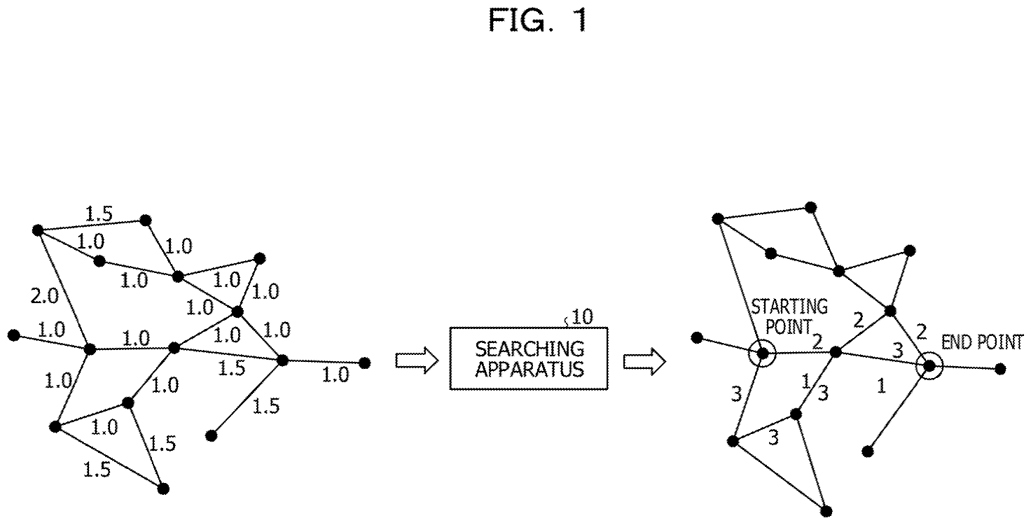

FIG. 1 is a diagram for explaining a searching apparatus 10 according to Embodiment 1. The searching apparatus 10 illustrated in FIG. 1 is an example of a computer apparatus that searches k-shortest paths from a starting point to an end point, For example, the searching apparatus 10 receives, as input data, graph data that is a weighted graph including edges for which weights are set and that is an undirected graph in which the edges do not have directions. The searching apparatus 10 then sets a starting point and an end point among vertices in the graph data.

Next, the searching apparatus 10 obtains the number of searches desired by a user among paths coupling the starting point and the end point and uses a value lower than the obtained number of searches and a value relating to the number of intermediate points set for the obtained graph data to determine the number of paths from both of the starting point and the end point to a point where the searches meet in nodes of the graph data. After that, the searching apparatus 10 searches paths coupling the determined starting point and end point based on the determined number of paths and outputs the searched paths.

For example, for a higher processing speed, the searching apparatus 10 limits the number of shortest paths held at intermediate points including joint points to be equal to or lower than k by using a method acquired by arranging the extended Dijkstra method that extends Dijkstra method to shortest path search so as to further perform bidirectional search. In the example in FIG. 1, the searching apparatus 10 searches the shortest three paths of the first path, the second path and the third path among the paths from the starting point to the end point,

### Functional Configuration of Searching Apparatus 10

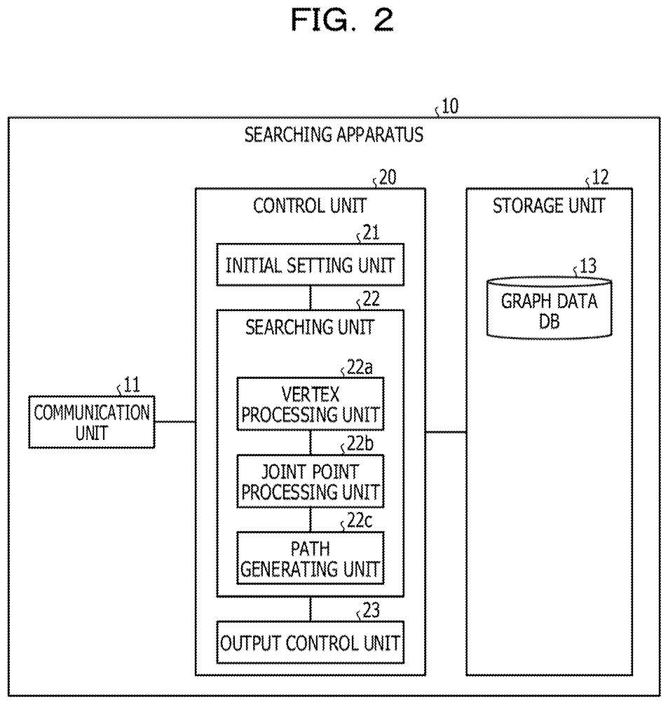

FIG. 2 is a functional block diagram illustrating a functional configuration of the searching apparatus 10 according to Embodiment 1. As illustrated in FIG. 2, the searching apparatus 10 includes a communication unit 11, a storage unit 12, and a control unit 20.

The communication unit 11 is a processing unit that controls communication with another device and is a communication interface, for example. For example, from a terminal of a manager, the communication unit 11 receives graph data and receives an instruction to search k-shortest paths. The communication unit 11 transmits a search result to a designated terminal and transmits a screen displaying the search result to the designated terminal.

The storage unit 12 is an example of a storage device that stores programs and data, and is, for example, a memory, a hard disk, or the like, The storage unit 12 stores a graph data DB 13.

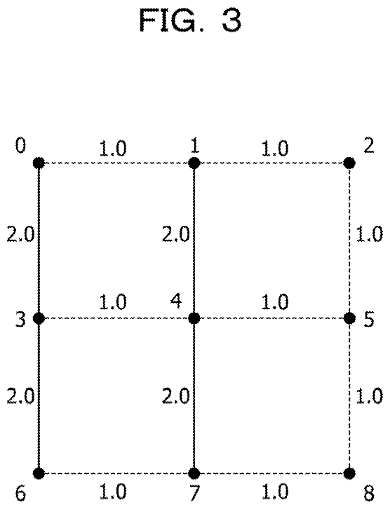

The graph data DB13 is a database that stores graph data to be searched. FIG. 3 is a diagram illustrating an example of graph data to be stored in the graph data DB 13. As illustrated in FIG. 3, the graph data to be searched is a weighted and undirected graph including nine vertices from 0 to 8 and edges for which weights are set, In other words, for example, a weight is a length of an edge.

More specifically, a weight “1.0” is set for an edge between a vertex 0 and a vertex 1, an edge between the vertex 1 and a vertex 2, an edge between the vertex 2 and a vertex 5, an edge between a vertex 3 and a vertex 4, an edge between the vertex 4 and the vertex 5, an edge between the vertex 5 and a vertex 8, an edge between a vertex 6 and a vertex 7, and an edge between the vertex 7 and the vertex 8. A weight “2.0” is set for an edge between the vertex 0 and the vertex 3, an edge between the vertex 3 and the vertex 6, an edge between the vertex 1 and the vertex 4, and an edge between the vertex 4 and the vertex 7. Hereinafter, in graph data, edges with a weight of “1.0” are indicated by broken lines, and edges with a weight of “2.0” are indicated by solid lines.

The control unit 20 is a processing unit that manages the entire searching apparatus 10 and is, for example, a processor or the like. The control unit 20 has an initial setting unit 21, a searching unit 22, and an output control unit 23. Each of the initial setting unit 21, the searching unit 22 and the output control unit 23 is an example of an electronic circuit included in the processor, an example of a process executed by the processor, or the like.

The initial setting unit 21 is a processing unit that receives settings from a user such as a manager and defines the settings, For example, the initial setting unit 21 defines a starting point and an end point of k-shortest paths, the number of searches (value of k) and the like.

The searching unit 22 has a vertex processing unit 22a, a joint point processing unit 22b, and a path generating unit 22c. The searching unit 22 is a processing unit that stores and holds a result of searching processing in progress in a data structure such as a priority queue and executes searches for k-shortest paths by using the values defined by the initial setting unit 21 on graph data stored in the graph data DB 13.

The vertex processing unit 22a is a processing unit that determines candidates for the shortest paths from both of the starting point and the end point to the vertices. More specifically, the vertex processing unit 22a executes bidirectional search and holds a designated number (k) of paths in increasing order of length among a plurality of paths to vertices. For example, when “2” is set as k, the number of path to be held is set as “1”. Hereinafter, a path from a vertex A to a vertex B with a length of L therebetween is expressed as L[vertex B, vertex A]. When another vertex exists between the vertex A and the vertex B, it is placed in order. For example, when a vertex C and a vertex D exist in order between the vertex A and the vertex B, it is expressed as L[vertex B, vertex D, vertex C, vertex A].

The example in FIG. 3 will be described by assuming that 2(=k) is set for the k-shortest paths and “1” is set as a threshold value for the number of paths to be held. The vertex processing unit 22a identifies 1.0[1, 0] as a path from the vertex 0 to the vertex 1 with respect to the vertex 1 adjacent to the vertex 0 that is a starting point. Because the number of held paths to the vertex 1 is 0 that is lower than the threshold value (1), the vertex processing unit 22a holds 1.0[1, 0] as a path of the vertex 1. Also, with respect to the vertex 3 adjacent to the vertex 0 that is the starting point, the vertex processing unit 22a holds 2.0[3, 0] as a path from the vertex 0 to the vertex 3.

With respect to the vertex 5 adjacent to the vertex 8 that is the end point, the vertex processing unit 22a identifies 1.0[5, 8] as a path from the vertex 8 to the vertex 5. Because the number of paths to be held to the vertex 5 is 0 that is equal to or lower than the threshold value (1), the vertex processing unit 22a holds 1.0[5, 8] as a path to the vertex 5. Also, with respect to the vertex 7 adjacent to the vertex 8 that is the end point, the vertex processing unit 22a holds 1.0[7, 8] as a path from the vertex 8 to the vertex 7.

Next, with respect to the vertex 2 adjacent to the vertex 1 that has been searched, the vertex processing unit 22a identifies 2.0[2, 1, 0] as a path from the vertex 0 to the vertex 2. Because the number of paths to be held to the vertex 2 is equal to or lower than the threshold value (1), the vertex processing unit 22a holds 2.0[2, 1, 0] as a path to the vertex 2. Also, with respect to the vertex 4 adjacent to the vertex 1 that has been searched, the vertex processing unit 22a identifies 3.0[4, 1, 0] as a path from the vertex 0 to the vertex 4. Because the number of paths to be held to the vertex 4 is equal to or lower than the threshold value (1), the vertex processing unit 22a holds 3.0[4, 1, 0] as a path to the vertex 4.

With respect to the vertex 4 adjacent to the vertex 3 that has been searched, the vertex processing unit 22a identifies 3.0[4, 3, 0] as a path from the vertex 0 to the vertex 4. However, if the path is held, the number of held paths to the vertex 3 exceeds the threshold value (1). Furthermore, the length of the path “3.0[4, 1., 0] to the vertex 4 that has been already held is equal to the current holding target “3.0 [4, 3, 0]. Therefore, the vertex processing unit 22a abandons the current holding target “3.0[4, 3, 0]”. Also, with respect to the vertex 6 adjacent to the vertex 3 that has been searched, the vertex processing unit 22a identifies 4.0[6, 3, 0] as a path from the vertex 0 to the vertex 6. Because the number of paths to be held to the vertex 6 is equal to or lower than the threshold value (1), the vertex processing unit 22a holds 4.0[6, 3, 0] as a path to the vertex 6.

In this way, the vertex processing unit 22a limits the number of paths to be held to each of vertices in path search to the vertices by using a data structure such as a priority queue so that the workload may be reduced. The vertex processing unit 22a executes this processing in both directions from a starting point and an end point and executes the processing until all vertices or the desired shortest paths are searched.

The joint point processing unit 22b is a processing unit that identifies a joint point where a search from a starting point side and a search from an end point side are jointed by using paths to the vertices searched by the vertex processing unit 22a. More specifically, for example, the joint point processing unit 22b identifies, as a joint point, a vertex with a path that has been searched from an end point side if the vertex is with a path from a starting point side that has already been searched. The joint point processing unit 22b notifies the path generating unit 22c of information regarding the joint point.

For example, when a path “20[2, 5, 8]” from the end point to the vertex 2 is searched and held by the vertex processing unit 22a, the joint point processing unit 22b identifies the vertex 2 as a joint point if the path “2.0[2, 1, 0] to the vertex 2 searched from the starting point has already been searched. On the other hand, when the path “2,0[2, 5, 8]” from the end point to the vertex 2 is searched and held by the vertex processing unit 22a, the joint point processing unit 22b does not identify the vertex 2 as a joint point if the path to the vertex 2 searched from the starting point has not been searched,

The path generating unit 22c is a processing unit that generates k-shortest paths by using the search result by the vertex processing unit 22a and the identification result by the joint point processing unit 22b. When a joint point is identified, the path generating unit 22c generates a path by combining the path from the starting point to the joint point and the path from the end point to the joint point. The path generating unit 22c holds k generated paths at a maximum. Upon determination on whether the generated path is to be held or not, the path generating unit 22c complies with the limitation of the maximum k paths by deleting paths having a large weight (long path length).

Describing with reference to the example above, when the vertex 2 is identified as a joint point, the path generating unit 22c combines the path “2,0[2, 1, 0]” from the starting point to the joint point (vertex 2) and the path “2.0[2, 5, 8]” from the end point to the joint point (vertex 2) to generate a path “4.0[0, 1, 2, 5, 8] from the starting point to the end point. If the number of the currently held paths is lower than 2 (k=2), the path generating unit 22c holds the path “4.0[0, 1, 2, 5, 8]” as it is.

If the number of the currently held paths is equal to 2 (k=2) and there are other paths having a path length longer than 4.0, the path generating unit 22c deletes the longest path of the other paths and holds the path “4.0[0, 1, 2, 5, 8]”. if the number of the currently held paths is equal to 2 (k=2) and no other paths having a path length equal to or longer than 4.0 are held, the path generating unit 22c abandons the path “4.0[0, 1, 2, 5, 8]”. In this way, the path generating unit 22c holds the k-shortest paths by complying with the limitation of the number of paths to be held that is equal to or lower than k every time a joint point is identified.

The output control unit 23 is a processing unit that outputs the k-shortest paths generated by the searching unit 22. More specifically, for example, the output control unit 23 stores, in the storage unit 12 or the like, k paths generated and held by the path generating unit 22c when the execution of the processing on the vertices is completed by the searching unit 22. As a result of the k-shortest path search, the output control unit 23 transmits k paths to a terminal of a manager or outputs k paths to a display unit such as a display device.

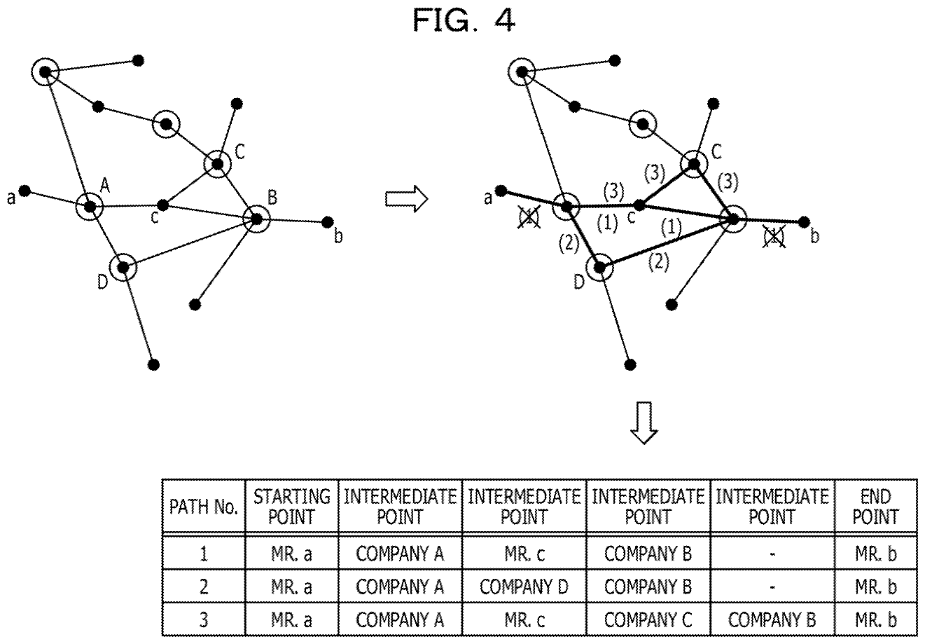

A more specific example of the k-shortest path search will be described below. FIG. 4 is a diagram illustrating an example from input graph data to an output result. The graph data in FIG. 4 are an unweighted graph having companies or presidents of companies as vertices, Black vertices indicate presidents and vertices having a white circle with a black circle at its center indicate companies, Deeply related companies or humans are coupled by edges. For example, related companies include affiliated companies or major stock holding companies. Examples of relationships between a human and a company correspond to a case where the human is the president or a major stockholder of the company.

In a case where certain two people are suspected to be related to fraud, the shortest path between the two people may be searched so that through which path the two people get acquainted with each other or other people or companies that relate to the fraud may be easily investigated. However, highly possibly, they are related through a path excluding the shortest path. In this case, a plurality of paths may be searched by k-shortest path search, and a k-shortest path result that is the search result may be displayed on a screen for highly precise investigation.

In the example in FIG. 4, Mr. a and Mr. b are related to fraud, In this case, Mr, a and Mr. b are set as a starting point and an end point, respectively, and three shortest path searches (k=3) are executed. It is assumed here that the searching unit 22 searches a path No. 1 that is the shortest path, a path No. 2 that is the second path, and a path No. 3 that is the third path. In this case, the output control unit 23 may generate and display a list including the shortest path “the starting point (Mr. a), the intermediate point (Company A, Mr. c, Company B) and the end point (Mr. b)”, the second path “the starting point (Mr. a), the intermediate point (Company A, Company D, Company B) and the end point (Mr. b)” and the third path “the starting point (Mr. a), the intermediate point (Company A, Mr. c, Company C, Company B) and the end point (Mr. b)”.

### Processing Flow

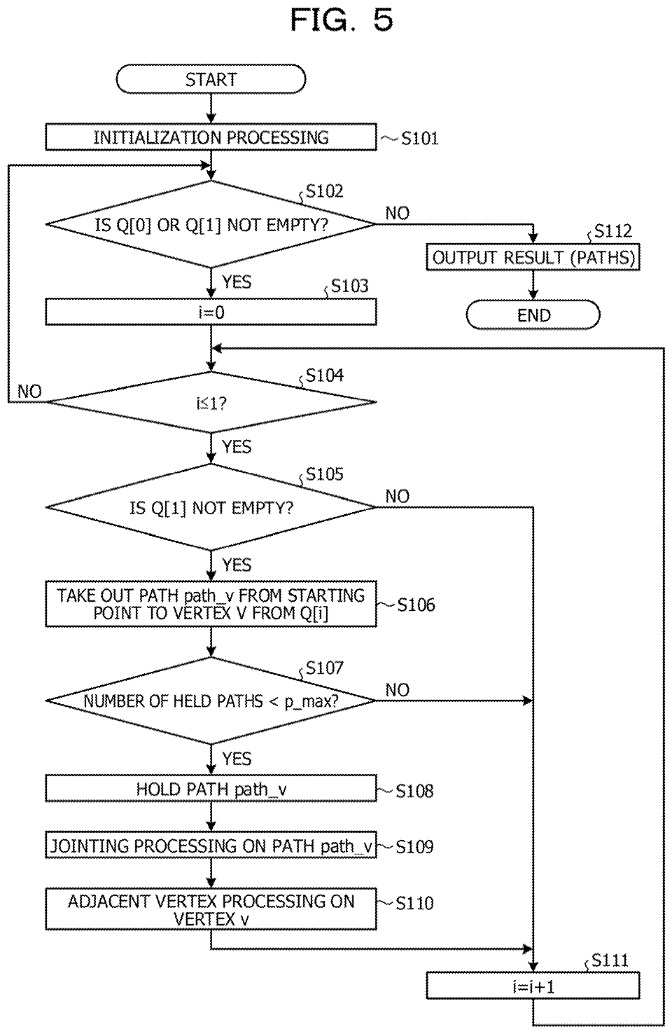

Next, an example will be described in which the aforementioned processing is specifically executed by using priority queues. FIG. 5 is a flowchart illustrating a processing flow according to Embodiment 1. The processing illustrated in FIG. 5 is executed alternately from the starting point side Q[0] and the end point side Q[1]. If one of the Qs becomes empty, the processing is executed on the other Q. If both of the Qs become empty, the searched paths are output.

As illustrated in FIG. 5, when the initial setting unit 21 is instructed to start the processing, the initial setting unit 21 executes an initializing process (S101). More specifically, for example, the initial setting unit 21 obtains graph data and sets a starting point and an end point and sets the number of searches (k) and the maximum number of paths pmax. The initial setting unit 21 initializes a priority queue “totalQ” into which shortest paths to be acquired are put and starting point side and end point side priority queues Q[0] and Q[1]. The smallest path to kth smallest path are put into totalQ, and they are abandoned in the (k+1)th and larger paths. The initial setting unit 21 further initializes P[0] and P[1] for holding starting point side and end point side paths for each vertex. A path list regarding the jth vertex is held in a list P[i][j].

Next, if Q[0] or Q[1] is not empty (S102, Yes), the searching unit 22 substitutes 0 for i (S103) and determines whether the current i is equal to or lower than 1 (S104).

If i is equal to or lower than 1 (S104: Yes) and Q[i] is not empty (S105: Yes), the searching unit 22 takes out from Q[1] a path pth_v from the starting point to a vertex v (S106). For example, the searching unit 22 holds the path path_v in P[i][v.id( )]. v.id( )is a number of the vertex v.

The searching unit 22 determines whether the number of held paths is lower than p_max or not (S107). If the number of held paths is lower than p_max (S107: Yes), the searching unit 22 executes processing of jointing paths path_v (S109). For example, if the point v is a joint point, the searching unit 22 joints path_v and a path P[opp(i)][v.id( )] and puts the result into totalQ. opp(i) is a function that returns the number of the opposite side of i, that is, the function returns 1 if i=0 and returns 0 if i=1.

After that, the searching unit 22 executes the joint processing on the vertex v (S110), increments i (S111) and executes the processing in S104. For example, the searching unit 22 generates a path path_w=[w, path_v] for a vertex w adjacent to the vertex v and put it into Q[i].

If the number of held paths is equal to or higher than p_max in S107 (S107: No), the searching unit 22 executes processing in S111 and subsequent steps, If Q[i] is empty in S105 (S105: No), the searching unit 22 executes the processing in S111 and subsequent steps.

If i is higher than 1 in S104 (S104: No), the searching unit 22 executes the processing in S102 and subsequent steps. If Q[0] and Q[1] are empty in S102 (S102: No), the searching unit 22 outputs the searched paths as a result (S112).

### Effects

In a case where the shortest paths the number of which is desired by a user are to be searched by bidirectional search based on extended Dijkstra method, the searching apparatus 10 limits information on paths held during searches, as described above. Thus, even when there are an enormous number of vertices, the searching apparatus 10 may search paths desired by a user with high precision, and, at the same time, the amount of computational complexity may be reduced.

### Embodiment 2

Next, detail algorithms of the searching processing to be executed by the searching apparatus 10 according to Embodiment 1 as described above will be described. Terms used in this embodiment will be described first, and then the algorithms will be described.

### Description of Terms

In a graph, a point is called a vertex, and a line is called an edge. A set of vertices in a graph is indicated by V, and a set of edges is indicated by E. When the graph is G, G=(V, E). This means that the graph G is a graph including a set V of vertices and a set E of edges.

A graph having an edge that has no direction is called an undirected graph, and a graph having an edge that has a direction is called a directed graph. For example, when all of roads are bidirectional, the road system may be expressed by an undirected graph. However, if a one-way road is included, the road system is expressed by a directed graph.

A graph having weighted edges is called a “weighted graph”, and a graph having unweighted edges is called an “unweighted graph”. For example, a railway network may be expressed as a weighted graph by defining vertices as stations and giving a distance or required time between stations to an edge between the corresponding vertices. On the other hand, when a human relationship is considered only by focusing on its friendship and intimacy of the relationship is not considered, the friendship may be expressed as an unweighted graph.

When two vertices are coupled by one edge, it is said that the two vertices are adjacent, A list of vertices adjacent to one vertex v is called an adjacent vertex list of the vertex v. If the graph is a weighted graph. a pair of an adjacent vertex and a length of the edge to the vertex is held as a list.

Regarding a “path”, when vᵢ₋₁, vᵢ are adjacent for an arbitrary i (1≤i≤n) in a vertex string [v₀, v₁, . . . , vₙ], the vertex string is called a path. In a directed graph, an edge from vᵢ₋₁ to vᵢ is required to be included in E. v₀ is called a “starting point” of a path, and vₙ is called an “end point”. This embodiment assumes that a vertex does not appear repeatedly on a path.

Regarding “length of a path”, each edge is considered to have a weight of 1, and a total of weights of edges on a path is called a “length of the path” or “path length”. Normally, a path between two vertices having the shortest length is called a “shortest path”. There is a possibility that a plurality of shortest paths exists normally. In this embodiment, not only the shortest path in a general sense but paths which may be called a predetermined number of semi-shortest paths in increasing order are also simply called “shortest paths”.

The k shortest paths including from the shortest path to the kth shortest path between one vertex vₛ to another vertex vₜ are called “k-shortest paths” where 1≤k and the processing for acquiring the k-shortest paths is called “k-shortest path search”. vₛ and vₜ are called a starting point and an end point, respectively. Bidirectional search includes searches from both of the starting point and the end point, as will be described below. In this sense, both of them may also be called a “departing point”. A path having a starting point and an end point that are matched is called a closed path. A point traced during a search between a starting point and an end point in k-shortest path search is called an “intermediate point”. A point that is a type of intermediate point where a path from a starting point and a path from an end point meet is called a “joint point”.

### Description of Algorithm

In order to acquire a shortest path, a process of “tracing” edges from a vertex is performed. How early this process is stopped is important for increasing the speed of the processing. In this embodiment, the speed of the search processing is increased by “reduction by approximation method” and “reduction by max (reduction of unnecessary tracing by using the length of the kth shortest path acquired as a candidate for a solution)”.

For example, for acquiring k-shortest paths, an approximation of the solution may be enough instead of an accurate solution. In a case of data analysis for acquiring a bypass of a traffic route or a communication channel or a human relationship, processing that provides a solution sufficiently close to an optimum solution at a higher speed may be desirable even at little sacrifice of accuracy. Ina case of a traffic route, a method that acquires a solution in three seconds even with slightly lower precision is more preferred than a method that provides an accurate solution in one minute. In the present age of big-data, data analysis is required. In this case, calculation of the shortest path or shortest paths up to the kth shortest path is required in many pairs of two vertices. It is predictable that the processing takes an enormous amount of time with large scale data. In this case, it may be considered that the speed often has higher priority than precision.

The “reduction by approximation method” involves parameter adjustment. Therefore, the parameter optimization is automated. Graphs include undirected/directed graphs and weighted/unweighted graphs, Four (2×2) types of graphs are considered by combining them. This embodiment is applicable to all of the types. This embodiment assumes a weighted and undirected graph.

### Reduction by Approximation Method

One of differences between this embodiment and a general method is a limitation to k or lower of the number of paths from a starting point or an end point at an intermediate point including a joint point. The precision defined as being acceptable by a user is Pₘᵢₙ. This setting may be changed arbitrarily by a user.

According to this embodiment, the number of partial shortest paths to be acquired from a departing point to an intermediate point is limited to k or lower. The reduction of the searching processing increases the speed. The limited number of partial shortest paths is called a “maximum number of paths” and is indicated by pₘₐₓ hereinafter. Random reduction of pₘₐₓ increases the speed. However, the precision may possibly decrease. Accordingly, in view of the precision and the speed, pₘₐₓ is limited to the extent expressed by Expression (1) where α is a parameter. With the limitation, kₛ (≤pₘₐₓ) partial shortest paths from a starting point and kₜ (≤pₘₐₓ) partial shortest paths from an end point are acquired at a joint point. The shortest paths from the starting point and the end point are combined so that kₛ×kₜ shortest path candidates from the starting point to the end point may be acquired. The shortest paths up to the kth shortest path in increasing order are acquired from the shortest path candidates acquired at joint points to acquire a final result.

pₘₐₓ=α\sqrt{k} (1)

A reason why Expression (1) is valid will be described. By assuming that Expression (1) is satisfied and assuming that the starting point side and end point side partial shortest paths the number of which is indicated by the right side of Expression (1) are acquired at joint points, the partial shortest paths are combined at the joint points. Then, the shortest path candidates the number of which is indicated by Expression (2) are acquired.

(α\sqrt{k})²=α²k (2)

There are many joint points normally. When the number of joint points is c, “c×Expression (2)” shortest paths are totally acquired. The value is at least required to be higher than k. However, the acquired shortest paths may include redundant paths, and if a lower number of shortest paths are acquired, it does not satisfy the user's requirement of precision Pₘᵢₙ or higher. Therefore, some times of k is required to acquire. When the number is β, cα²k=βk as in expressed in Expression (3).

$$α = \sqrt{\frac{β}{c}} \qquad ( 3 )$$

Conversely, by setting the value as the value of α, the result may satisfy the user's satisfaction of precision. While β and c are handled as fixed numbers, these values may be influenced by k and positions of the starting point and the end point. Because of this, α may also vary. Performing statistic processing may be considered which changes k in a range to be used by a user and changes the starting point and the end point and acquires a maximum value or a mean value of α in the changed conditions. When the requirement for precision is strict, the maximum value may be acquired. If it is not so strict, the mean value may be acquired. Values of k may be divided into several ranges, and α may be determined for each of the ranges. Optimization of the parameter α will be described below.

### Reduction by Max

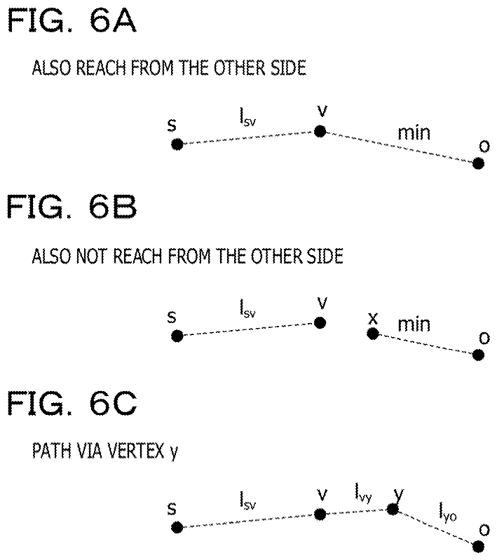

Reduction by max assumes that a candidate for the kth shortest path (the kth shortest one among the acquired shortest paths though whether it is truly the kth shortest path or not is unknown) has been acquired. It is assumed that the length is max. According to this method, a path traced from a departing point to the vertex v and its length are managed in a priority queue and is to be put into and taken out from the priority queue. FIGS. 6A to 6C are diagrams for explaining relationships between a vertex v and a starting point and the vertex v and an end point.

As illustrated in FIGS. 6A to 6C, it is assumed that one departing point is s, the other departing point is o, a vertex taken out from a queue is v and the length of the path from the departing point to v is lₛᵥ. In this embodiment, bidirectional searches are performed by using two queues including a queue Qₛ for the departing point s side and a queue Qₒ for the other departing point o side. Hereinafter, when a path is dear from the context, the length of the path between vertices x and y is indicated by l_{xy}.

The broken lines in FIGS. 6A to 6C indicate paths from a starting point or an end point. In this case, two events are problems. More specifically, for example, the problems are (1) whether a further path from v is to be searched and (2) if a further path is to be searched and when a vertex adjacent to v is w, whether a further path from w is to be searched or whether the path and length from the departing point to w is to be put into Qₛ.

Regarding (1), cases illustrated in FIG. 6A where a path from the other side reaches the vertex v and in FIG. 6B where the path from the other side does not reach vertex v are considered. More specifically, for example, referring to FIG. 6A, the path from the vertex o has reached the vertex v where the length of the shortest path is min. Referring to FIG. 6B, the path from the vertex o has not reached the vertex v where the minimum value of the shortest path put into the queue Qₒ is min. In FIG. 6B, the beginning of the queue Qₒ, that is, the leading end of the shortest path having a length of min is a vertex x.

In both cases, if an inequality “max≤lₛᵥ+min” (this inequality will simply be called “criterion with max”) is satisfied, a shortest path that is shorter than max may not be acquired even by further extending the search from the vertex v. In other words, this means that the search may be stopped without requiring the extension from the vertex v. The reason will be described below.

For example, it is assumed that a shortest path shorter than max is acquired by combining the path with the shortest path from the other side at the vertex y reached by further tracing the path from the vertex v. In this case, as illustrated in FIG. 6C, lᵥₒ=l_{vy}+l_{yo}, and a relationship min≤lᵥₒ is required to be satisfied. This will be further examined by dividing it into two. In the case in FIG. 6A, the already reached path is the shortest path from the vertex o to the vertex v. Because of the definition of the shortest path, the length of the path via the currently acquired y is required to be equal to or longer than min.

In the case in FIG. 6B, when the path from the vertex s reaches the vertex v, the path from the vertex o has not reached the vertex v. Therefore, the relationship min≤lᵥₒ is required to be satisfied. If lᵥₒ<min, the path via the acquired y is supposed to have been already taken out from the queue because the queue is a priority queue, which is contrary to the assumption that the path has not reached yet.

Hereinafter, this is satisfied in a case where the vertex taken out from the queue Qₛ is v. Because the queue is a priority queue, the length of the path to the vertex v taken out after this is equal to or longer than the length of the path to the currently taken vertex v. Because of this, hereinafter, in a case where the leading end of the path taken out from the queue Qₛ is the vertex v, no further extension is required irrespective of the length of the path. It is noted here that no extension is required at the vertex v from the vertex s side but it may not be said that no extension at the vertex v from the vertex o side is required.

(2) where further extension from the vertex v may be performed will be examined. In this case, the vertex w adjacent to the vertex v is investigated. Whether further search from the vertex w is to be performed or not, that is, whether the path to the vertex w is to be put into the queue Qₛ is problem. Also in this case, for the exactly same reason as that for the vertex v, if max≤l_{sw}+min is satisfied, no extension further from the vertex w is required. Therefore, the path is not required to be put into the queue Qₛ. l_{sw} is calculated by l_{sw}=lₛᵥ+l_{vw} where l_{vw} is a length of the edge between the vertices v and w,

However, unlike the case of the vertex v, in a case where the leading end of the path taken out from the queue Qₛ from now on is the vertex w, it may not be said that no further extension is required irrespective of the length of the path to the vertex w. This is because there is a possibility that the vertex w is not the leading end of the path taken out from the queue Qₛ and a shorter path than l_{sw} is taken out from the queue Qₛ from now on. In other words, for example, it may be said that the path to w acquired by adding w to the path having l_{sw} from s to v may not be put into the queue.

Therefore, the extension from the departing point side may be stopped at the vertex v in (1) and the path to the vertex w via the vertex v may not be put into the queue Qₛ, in (2), which contribute to the corresponding increase of the processing speed. Actually, the speed is increased about 10 times in Embodiment 4, which will be described below. The deletion of unnecessary tracing based on the criterion with max described above will simply be called “Reduction by max”.

### k-Shortest Path Search Processing by Approximation

Next, k-shortest path search processing by approximation will be concretely described. A structure of a graph and a structure of a queue will be described first, and a specific flow of the processing will then be described.

### 1. Data Structures of Graph

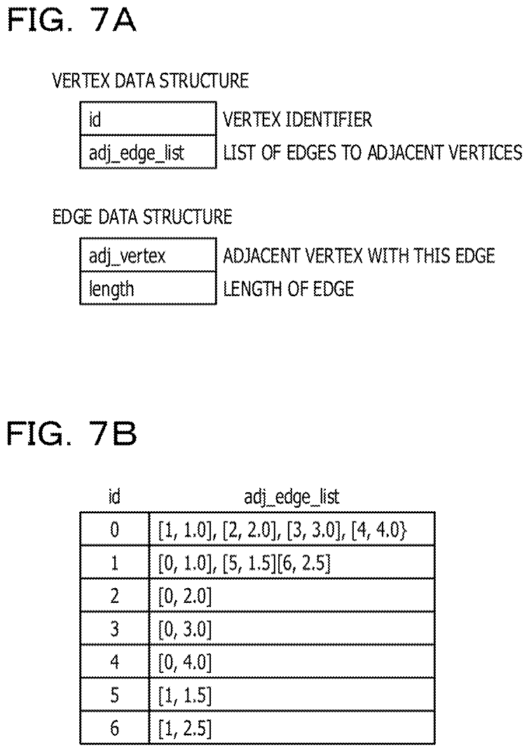

FIGS. 7A and 7B are diagrams illustrating a data structure example of a graph according to Embodiment 2. As illustrated in FIGS. 7A and 7B, a graph is represented by expressing a vertex and an edge by using data structures. FIG. 7A illustrates data structures representing a vertex and an edge. The data structure of a vertex includes an identifier (id) of the vertex and a pointer to a list (adj_edge_list) of an edge to an adjacent vertex where the list is a synonym of an arrangement. The data structure of an edge includes a pointer to an adjacent vertex (adj_vertex) that the edge couples and the length (length) of the edge.

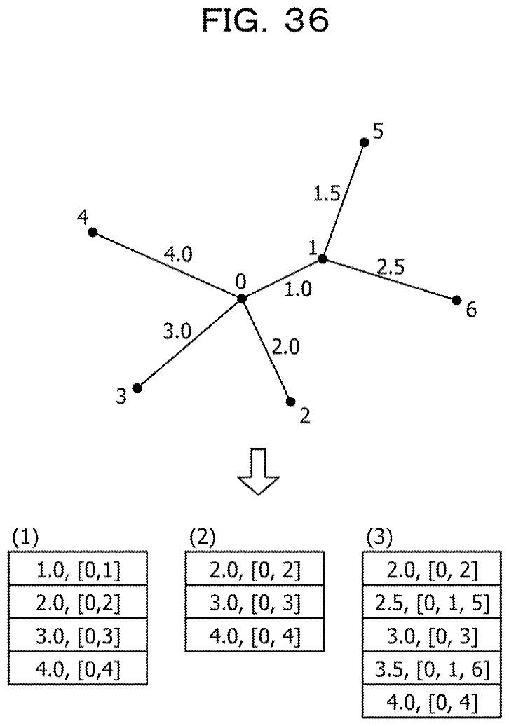

FIG. 76 illustrates a data structure of the graph based on the graph illustrated in FIG. 36, for example. A list of edges to adjacent vertices “adj_edge_list” is presented for each vertex (id). In the example in FIG. 7B, to the vertex 0 having a vertex id 0, an edge to the vertex 1 with a weight of 1.0, an edge to the vertex 2 with a weight of 2.0, an edge to the vertex 3 with a weight of 3.0 and an edge to the vertex 4 with a weight of 4.0 are coupled.

### 2. Maximum Number of Paths

As described above, the maximum number pₘₐₓ of paths is “ceil (Expression (1)”. In this case, “ceil(x)” is a function that rounds up a floating point number x to an integer.

### 3. Priority Queues

The following three types of priority queues are used in the shortest path search, When the length of a shortest path is “path_length” and a path is “path”, the pair “path_length, path] or only “path_length” is put into a priority queue.

### 3.1 Total Queue

A total queue is represented by “totalQ”. When the length of a shortest path is “path_length” and a path is “path”, the pair [path_length, path] is put into the totalQ” for each of the shortest path to the kth shortest path from a starting point to an end point. The “totalQ” may store a maximum of k data pieces. When more data pieces are to be stored, a path having a highest “path_length” is deleted. The term “maximum value of “totalQ”” refers to a maximum length of lengths of stored paths, which may be referred by “total.max( )”. For example, in a case where a new path is to be stored in “totalQ” already storing k paths, the new path is not stored if the length of the path is equal to or higher than the maximum value. The “totalQ” initially has an empty state, and the number of shortest paths stored in the “totalQ” may be referred by “totalQ.len( )”. len( ) is a function that returns an element of not only totalQ but also a general list and is used in the following other lists. In this embodiment, totalQ.len( ) is applied which means that totalQ is a first argument of the function len( ) and has the same meaning as len(totalQ). Generally, x.f( ) has the same meaning as f(x).

### 3.2 Starting Point Queue and End Point Que

The priority queue for the starting point side is represented by “Q[0]” and the priority queue for the end point side is represented by “Q[1]”. Because this embodiment applies bidirectional search, two queues are prepared. It is assumed that the starting point side is represented by 0 and the end point side is represented by 1 according to this embodiment.

For example, when the path length of a partial shortest path to a certain vertex is “path_length” and the path is “path”, the pair [path_length, path] is stored in a priority queue. While a path is not generally stored according to Dijkstra method, a plurality of paths is required to be memorized in the shortest path search. “Q[0]” initially stores [0.0,[vₛ]] when the starting point is vₛ, and “Q[1]” initially stores [0.0,[vₜ]] when the end point is vₜ. The “path_length” of the shortest path among paths stored in Q[i] (i=0, 1) or the path stored at the beginning may be referred by “Q[i].min( )”.

### 3.3 Each Vertex Queue

Two priority queues “q0” and “q1” are prepared for vertices, and the lengths of the partial shortest paths from the starting point and the end point to the vertex v are stored in “q0” and “q1”. A maximum of pₘₐₓ shortest path lengths “path_length” are stored in the “q0” and “q1”. In a case where pₘₐₓ path lengths have already been stored and if “path_length” of a new path length is equal to or higher than the highest value of the stored path lengths, the new path length is not stored.

When a new path length is actually stored, that is, when the number of stored path lengths is lower than pₘₐₓ or lower than a maximum value, “q0” or “q1” returns “true” and otherwise returns “false”. [q0, q1] is stored in q[v.id( )] in the list q, and q0 and q1 are referred by q[v.id( )][0] and q[v.id( )][1], respectively. In this case, “v.id( )” is a function that returns an identifier of v (one of the numbers from 0 to n−1 given to each vertex where the number of vertices is equal to n).

The length of a path is to be stored in “q0” or “q1” because, if the length is equal to or lower than the pₘₐₓth length, the path is stored in Q[0] or Q[1] and, if the length is higher than the pₘₐₓth length, the path is abandoned based on the policy of this embodiment. In both cases, the path is not required to be stored in“q0” or “q1”. [q] initially stores [0.0] for the values of q[s][0], q[t][1][q] where the vertex identifies of the starting point and the end point are s and t, respectively and stores an empty list [ ] for the other elements.

### 3.4 Partial Shortest Path List

A list that manages partial shortest paths reaching from the starting point side and the end point side to the vertex v is P, and P[v.id( )][i] represents a list of a plurality of, generally, shortest paths reaching the vertex v on the i (i=0, 1) side. In other words, if i=0, it represents a list of paths reaching from the starting point to the vertex v. If i=1″ it represents a list of paths from the end point. The kth shortest path is represented by P[v.id( )][i][k−1]. Each shortest path is represented by [path_length, path], like the total queue, starting point queue and the end point queue. “path_length” and “path” of the kth shortest path may be referred by “P[v.id( )][i][k−1].path_length” and “P[v.id( )][i][k−1].path”, respectively. An initial state of P is a list [ ] where all elements are empty.

### 3.5 List that Manages Joint Point

Whether the vertex v is a joint point or not is represented by “is_joint[v.id( )]” in a list “is_joint”. In other words, for example, if the value is true, it means that the vertex v is a joint point. At an initial state of the list “is_joint”, all elements have False.

### 3.6 List Indicating Possibility of Extension

“is_extended_list[v.id( )][i]” in a list “is_extended_list” indicates whether the search is to be extended from the vertex v. For example, if i=0, it represents that a search reaches from the starting point to the vertex v. If i=1, it represents that a searches reaches from the end point to the vertex v. In other words, for example, if the value is true, the leading end (or search) is to be extended further from the vertex v. At the initial state of “is_extended_list”, all elements have True.

### 4. Flowchart of k-Shortest Path Searching Processing

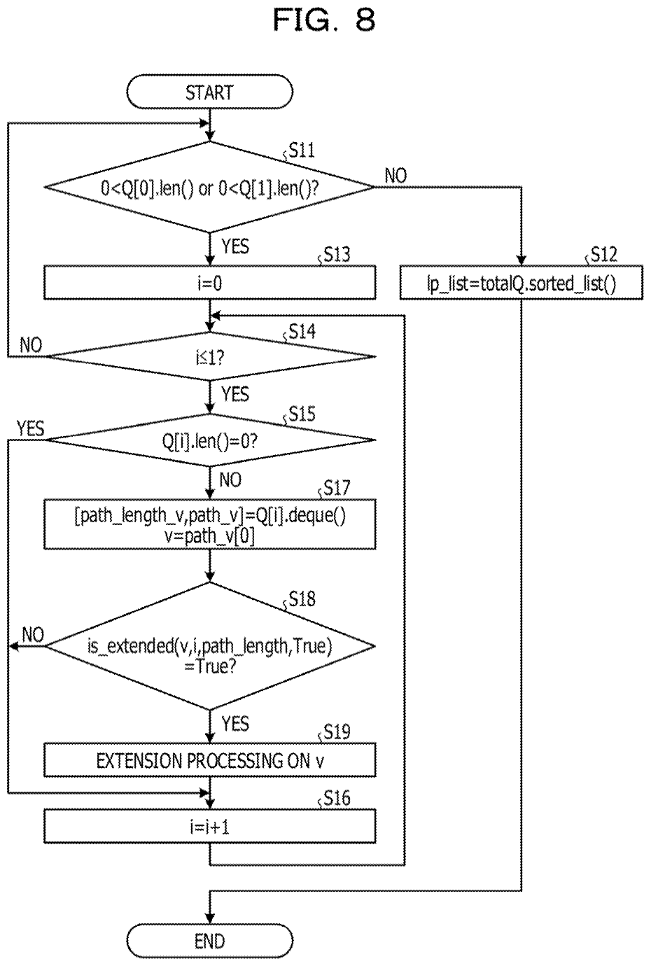

FIG. 8 is a flowchart illustrating a flow of k-shortest path searching processing according to Embodiment 2. As illustrated in FIG. 8, “0<Q[0].len( ) or 0<Q[1].len( )” is satisfied (S11: Yes), the searching unit 22 in the searching apparatus 10 substitutes 0 for i (S13) and determines whether “i≤1” is satisfied or not (S14).

If “i≤1” is satisfied (S14: Yes), the searching unit 22 determines whether “Q[i].len( )=0” is satisfied or not (S15). If it is satisfied (S15: Yes), i is incremented (S16). The processing in S14 and subsequent steps is repeated.

On the other hand, if “Q[i],len( )=0” is not satisfied (S15: No), the searching unit 22 takes out the first data of Q[i], sets the length to path_length_v and the path to path_v and sets the 0th element of path_v to v (S17). Q[i].deque( ) is a function that takes out the first data of the queue, and the value of Q[i].deque( ) is a list [l,p] including a pair of a path length l and a path p. Because the queue stores lengths of paths and paths in increasing order of the path length, the shortest path is taken out. Generally, [a,b]=[c,d] means that c is set to a and d is set to b. After that, the searching unit 22 determines whether the list “is_extended(v,i,path_length,True)” is True or not (S18). If it is “True” (S18: Yes), processing for extending the vertex v is executed (S19). After the extension processing, the processing in S16 and subsequent steps is repeated.

If the list is_extended(v,i,path_length)” is not “True” (S18: No), the searching unit 22 repeats the processing in S16 and subsequent steps. If “i≤1] is not satisfied in S14 (S14: No), the searching unit 22 returns to S11 and repeats processing in subsequent steps. If “0<Q[0].len( ) or 0<Q[1].len( )” is not satisfied in S11 (S11: No), the searching unit 22 substitutes the value returned, by “totalQ.sorted_list( )” for a variable lp_list (S12) and ends the processing.

Describing the aforementioned processing more specifically, the entire processing is continued if the priority queue Q[0] or Q[1] is empty as expressed by the condition “0<Q[0].len( ) or 0<Q[1].len( )”. Then, the last vertex v in the partial shortest path from the departing point is taken out for [path_length_v,path_v] taken out from Q[0] or Q[1] that is not empty based on “v=path_v[0]”.

“len( )” is a function (method) that returns the number of elements stored in a list such as the number of elements stored in a priority queue. “sorted_list( )” is a function that returns a list acquired by sorting a pair [l,p] of a path length I and a path p stored in “totalQ” in increasing order of l, that is, a list of a pair of a length of k shortest paths and the paths to be acquired by this algorithm.

### 5. Flowchart of Extension Processing

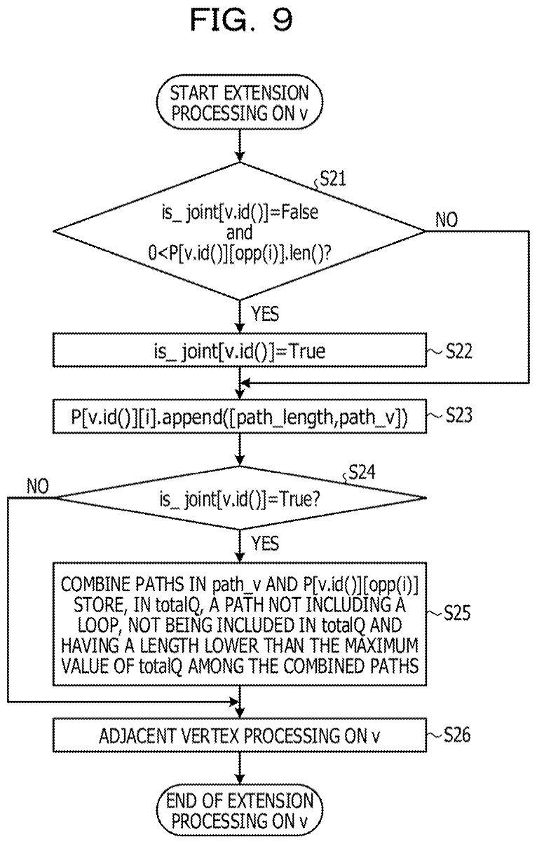

FIG. 9 is a flowchart illustrating a flow of v extension processing according to Embodiment 2. As illustrated in FIG. 9, “is_joint[v.id( )]=False and 0<P[v.id( )][opp(i)].len( )” is satisfied (S21: Yes), the searching unit 22 in the searching apparatus 10 substitutes “True” for “is_joint[v.id( )]” (S22).

Next, the searching unit 22 adds [path_length,path_v] to P[vid][i] based on “P[v.id( )].append([path_length,path_v])” (S23). The searching unit 22 then determines whether “is_joint[v.id( )]” is “True” or not (S24).

If “is_joint[v.id( )]” is “True” (S24: Yes), the searching unit 22 executes processing in S25. More specifically, the searching unit 22 combines paths in “path_v” and “P[v.id( )][opp(i)]”. The searching unit 22 then stores, in totalQ, a path not including a loop, not being included in totalQ and having a length lower than the maximum value of totalQ among the combined paths.

After that, the searching unit 22 executes adjacent vertex processing on the vertex v (S26). If “is_joint[v.id( )]” is not “True” in S24 (S24: No), the searching unit 22 executes processing in S26 without executing the processing in S25. If “is_joint[v.id( )]=False and 0<P[v.id( )][opp(i)].len( )” is not satisfied in S21 (S21: No), the searching unit 22 executes the processing in S23 without executing the processing in S22.

Describing the aforementioned processing more specifically, the condition “is_joint[v.id( )]=False” represents that the vertex v is not a joint point, and the condition “0<P[v.id( )][opp(i)].len( )” represents the number of partial shortest paths from the departing point on the other side to the vertex v is higher than 0, that is, the path has already reached from the departing point on the other side to the vertex v and the vertex v becomes a joint point at this time. Accordingly, “is joint[v.id( )]=True is defined. opp(i) is a function that returns the opponent of i. In other words, for example, 1 is returned if i=0, and 0 is returned if i=1. [path_length,path_v] is added to P[vid][i] based on “P[v.id( )].append([path_length,path_v])”.

Then whether the vertex v is a joint point or not based on “is_joint_list[v.id( )]=True”. If so, paths of “path_v” and “P[v.id( )][opp(i)]” are combined. In other words, for example, partial shortest paths stored in [path_length,path_v] and P[vid][opp(i)] are combined to form a shortest path from the starting point to the end point. In a case where three conditions that the formed shortest path does not have a loop, is different from the shortest path stored in totalQ and is lower than the maximum value of totalQ are satisfied, the formed shortest path is stored in totalQ.

The path combination will be described more specifically. It is assumed that “P[v.id( )][opp(i)]” stores [[l₁,p₁], [l₂,p₂], . . . [lₖ,pₖ]]. “lᵢ” is a path length, and “pᵢ” is a path. These paths and [path_length_v,path_v] are combined. In other words, for example, [path_len+lᵢ,path_v+pᵢ] (i=1, 2, . . . , k) is formed. Finally, in order to extend the path from the vertex v, processing relating to vertices adjacent to the vertex v is performed.

### 6. Flowchart of Adjacent Vertex Processing

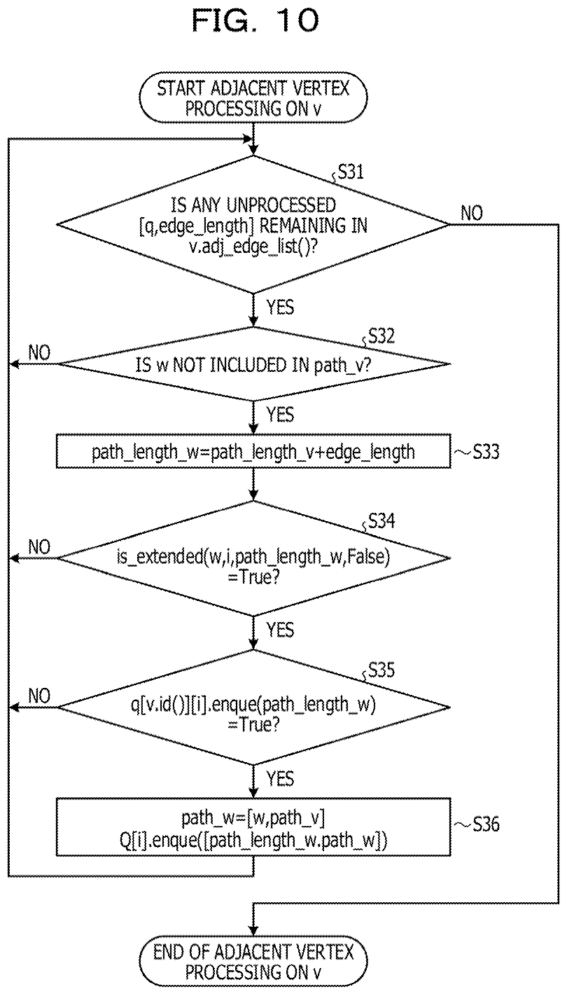

FIG. 10 is a flowchart illustrating a flow of processing for adjacent vertices of v according to Embodiment 2. As illustrated in FIG. 10, if “v.adj_edge_list( )” has an unprocessed [w,edge_length] (S31: Yes), the searching unit 22 in the searching apparatus 10 determines whether “w” is included in “path_v” or not (S32).

If “w” is not included in “path_v” (S32: Yes), the searching unit 22 substitutes “(path_length_v)+(edge_length)” for “path_length_w” (S33).

Whether “is_extended(w,i,path_length_w,False)” is “True” or not is determined (S34). If it is “True”, the processing in S35 is executed,

If “q[v.id][i].enque(path_length_w)” is “True” (S35: Yes), the searching unit 22 generates a path to “w” based on “path_w=[w,path_v]” and stores “path_length_w,path_w” in Q[i] (S36). After ghat, the processing in S31 and subsequent steps is repeated.

If “q[v.id][i].enque(path_length_w)” is not “True” in S35 (S35: No), if “w” is included in “path_v” in S32 (S32: No) and if “is_extended(w,i,path_length_w,False)” is not “True” in S34 (S34: No), the searching unit 22 repeats the processing in S31 and subsequent steps.

If “v.adj_edge_list( )” does not have an unprocessed [w,edge_length] in S31 (S31: No), the searching unit 22 ends the processing.

Describing the aforementioned processing more specifically, “v.adj_edge_list( )” is a function that returns a list (which will be called “adjacent vertex list) of a pair “w,edge_length” of a vertex w adjacent to the vertex v and the length “edge_length” of the edge between the vertex b and the vertex w. If an unprocessed “w,edge_length” remains, the processing is continuously executed.

Next, whether the vertex w is not included in the path to the vertex v “path_v” is checked. This is because there is a loop if the vertex w already exists in the path.

Next, based on “path_length_w=path_length_v+edge_length”, the length of a shortest path from the departing point to the vertex w is acquired. Then, whether “is_extended(w,i,path_length_w,False)” is “True” or not is determined. If it is “True”, whether path_length_w with the value of q_list[w.id( )][i].enque(path_length_w) may be stored in the priority queue. If it may be stored, it means that path_length_w is within the pₘₐₓth paths that have reached the vertex w. In other words, for example, there is a possibility that the path may be extended further after the vertex w. The expression, “there is a possibility” is used because there is also a possibility that a shortest path shorter than the path reaches the vertex w after this, and the shorter path is not within pₘₐₓ.

Accordingly, a path to the vertex w is generated based on path_w=[w,path_v], and “path_length_w,path_w” is stored in Q[i] based on Q[i].enque([path_length_w,path_w]). By using path_w=[w,path_v] and the path path_v to the vertex v, path_w may be efficiently defined.

### 7. Flowchart of Extension Determination Processing

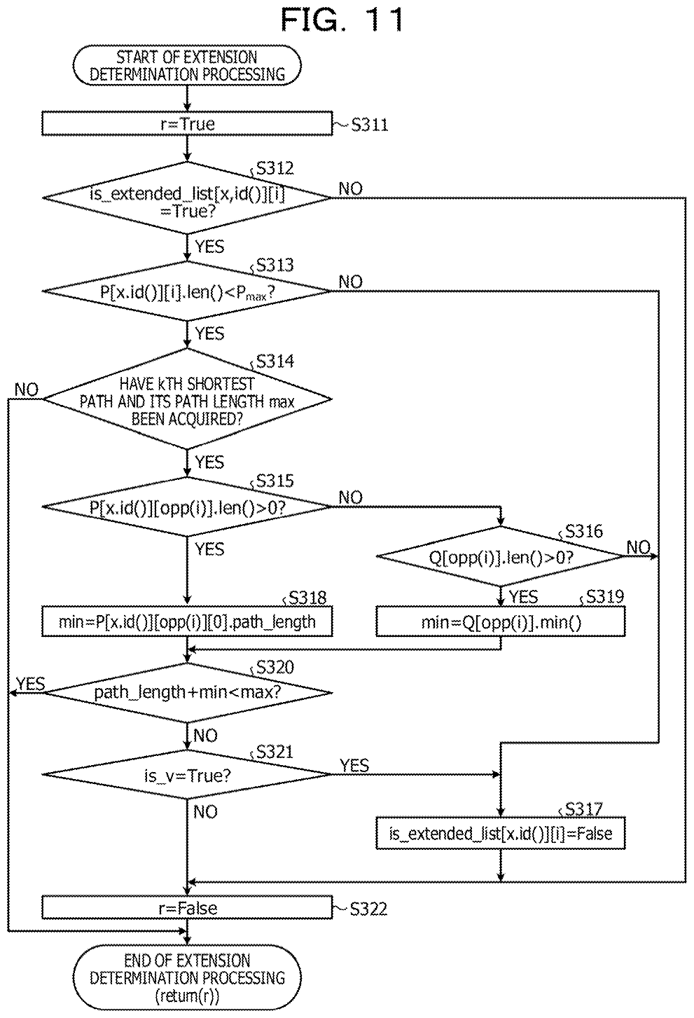

FIG. 11 is a flowchart illustrating a flow of is_extended (x, i, path_length. is_v) that is a function that performs extension determination processing according to Embodiment 2. x is a vertex. i is an integer that is 0 on the starting point side and 1 on the end point side, path_length is a distance from a starting point to the vertex x. is_v represents that the vertex x is v if it is True and, in other words, is invoked in the k-shortest path searching processing in FIG. 8, for example, and that the vertex x is w if it is False and, in other words, is invoked in the adjacent vertex processing in FIG. 10, for example. Other data structures excluding the parameters have been described above and may be referred from the function. As illustrated in FIG. 11, the searching unit 22 in the searching apparatus 10 substitutes True for r (S311) and determines whether “is_extended_list[x.id( )][i]” is True or not (S312).

Then, if “is_extended_list[x.id( )][i]” is True (S312 Yes), the searching unit 22 determines whether P[x.id( )][i].len( ) is lower than pₘₐₓ or not (S313).

If P[x.id( )][i].len( ) is lower than pₘₐₓ (S313: Yes), the searching unit 22 determines whether the kth shortest path has been acquired and the path length max has been acquired or not (S314).

If the kth shortest path and the path length max have been acquired (S314: Yes), the searching unit 22 determines whether P[x.id( )][opp(i)].len( ) is higher than 0 or not (S315). If P[x.id( )][opp(i)].len( ) is equal to 0 (S315: No) and if Q[opp(i)].len( ) is equal to 0 (S316: No), the searching unit 22 substitutes False for is_extended_list[x.id( )][i] (S317).

If P[x.id( )][opp(i)].len( ) is higher than 0 (S315: Yes), the searching unit 22 substitutes P[x.id( )][opp(i)][0].path.length for “min” (S318). If Q[opp(i)].len( ) is higher than 0 (S316: Yes), the searching unit 22 substitutes Q[opp(i)].min( ) for “min” (S319). The searching unit 22 after executing the processing in S317 defines “r=False” (S322), returns the value r, and ends the processing.

The searching unit 22 after executing the processing in S318 or S319 determines whether “path_length+min” is lower than max or not (S320). If “path_length+min” is lower than max (S320: Yes), the searching unit 22 keeps r=True, returns the value r and ends the processing.

If “path_length+min” is equal to or higher than max (S320: No), the searching unit 22 determines whether is_v is “True” (S321). If so, the searching unit 22 executes the processing S317 and, if not, performs the processing in S322. If the path length of the kth shortest path has not been acquired in S314 (S314: No), the searching unit 22 returns the value r and ends the processing.

The aforementioned processing will be described more specifically, FIG. 11 is a flowchart of the function is_extended( ) that determines whether the vertex v or the vertex w is to be extended.

If “is_extended_list[x.id( )][i]” is False in S312, it means that the path is not required to be extended further from the vertex x, Therefore, “r=False” is defined in S322, and the value r is returned. Then, the processing ends. If P[x.id( )][i].len( ) reaches pₘₐₓ in S313, the partial shortest path to this vertex is not required to be acquired no more, Therefore, “is_extended_list[x.id( )][i]” is False in S317. As a result, from the next processing time, “r=False” is instantly determined in S312. With this condition, reduction of the searching processing may be realized.

The expression “the kth shortest path has been acquired” in S314 means that k shortest paths have already been stored in the total queue “totalQ” (which is determined by determining whether the value of totalQ,len( ) is equal to k) and the expression “the path length is max” means that the value of totalQ.max( )is max. In this case, reduction by max is possible in S315 and subsequent steps or not is determined to realize high-speed processing,

For min acquired in S318 and S319, the value is set by S318 if the condition in S315 is satisfied and the value is set by S319 if the condition in S315 is not satisfied but the condition in S316 is satisfied, If the criterion with mx in S320 is satisfied, there is possibility that a shortest path from the starting point to the end point that is shorter than max is acquired. Therefore, it is determined that the extension at the vertex x is not stopped, Otherwise, the result depends on whether the vertex x is the vertex v or the vertex w in S321. If the vertex x is the vertex v, the extension processing from the departing point side at the vertex x is set to be stopped in S317. In other words, for example, unnecessary extension processing may be suppressed, leading to an increase of the speed of the processing. If the vertex x is the vertex w, the path extension to the vertex W is not simply performed due to the processing in S322. In other words, for example, it is determined that the path is not put into the queue. Though it may not be said that the extension is not performed in the vertex w, unlike the case of the vertex v, the suppression of storage of the path to the queue contributes to an increase of the speed of the processing.

### Specific Example of Operations

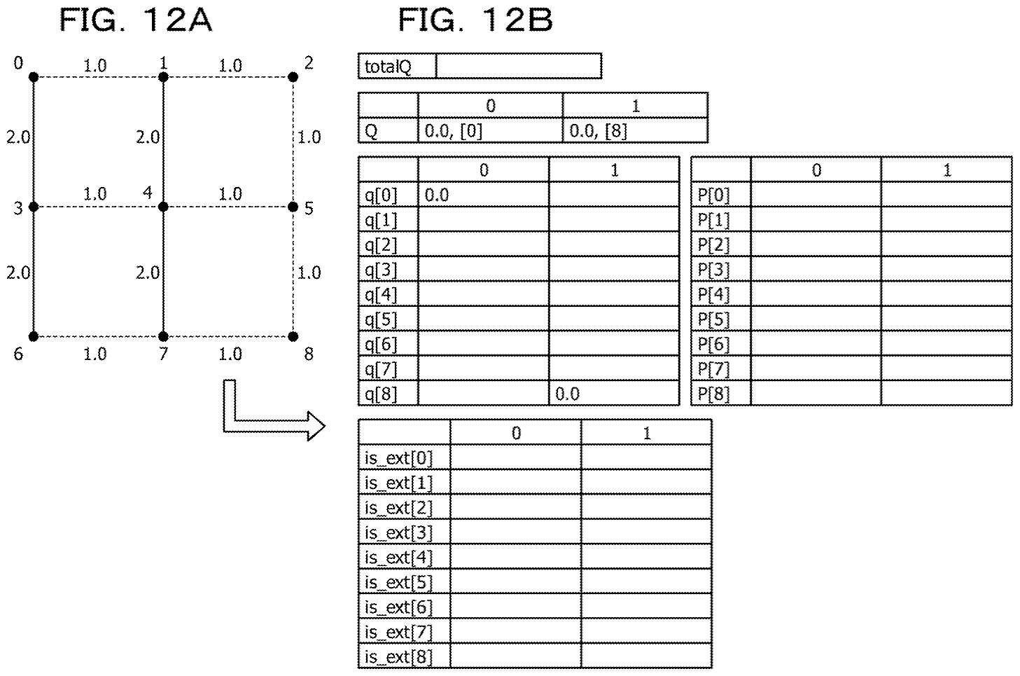

Next, a specific example of the aforementioned processing will be described with reference to FIGS. 12A to 27. FIGS. 12A and 12B are diagrams for explaining a queue state and an initialization state of a specific example according to Embodiment 2. As illustrated in FIG. 12A, a two-dimensional grid-like graph is used for description below. This graph includes nine vertices and 12 edges. Identifiers 0 to 8 are given to the vertices. A weight of 1.0 or 2.0 is given to each of the edges, Though distances between vertices are equal, but the times required between the vertices differ, for example. In this specific example, for clear distinction of weights, an edge with a weight of 2.0 is indicated by a solid line, and an edge with a weight of 1.0 is indicated by a broken line, Based on this, the subsequent drawings do not illustrate weights of the edges. It is assumed that the vertex 0 is a starting point and the vertex 8 is an end point. Shortest paths are acquired up to the second shortest path, which means k=2. The maximum number pₘₐₓ of paths is 1.

### Initial States

FIG. 12B is a diagram illustrating initial states of queues. The columns 0 and 1 of a queue Q corresponds to Q[0] and Q[1], respectively. When =0, 1, . . . , 8, the columns 0 and 1 of q[i], P[i], and is_extended_list[i] correspond to q[i][0], q[i][1], P[i][0], P[i][1], and is_extended_list[i][0] and is_extended_list[i][1], respectively. “is_extended_list” is abbreviated as “is_ext” for simplified drawings. Also, an initial value “True” is omitted, and, when the value is changed to “False” after that, “False” is indicated,

The drawings are further simplified as follows. The parentheses ([,]) indicating a list are omitted, and a vertex vᵢ is simply indicated by an integer i. A recursive structure of a path is simplified and is written as a flat list. For example, a path that is to be written as [3,[2,[1]]] is simplified to [3,2,1]. is_joint_list is not illustrated in the drawings. P[i] is written in bold type to indicate that is_joint_list[i] is True.

### Processing at Starting Point and End Point

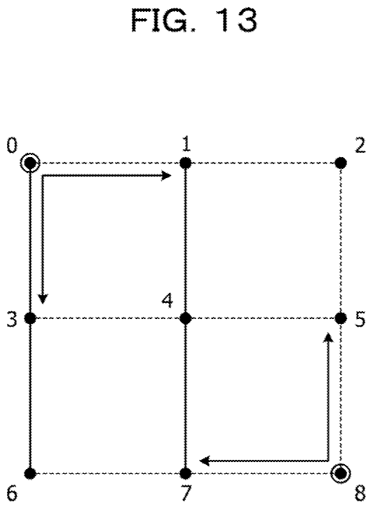

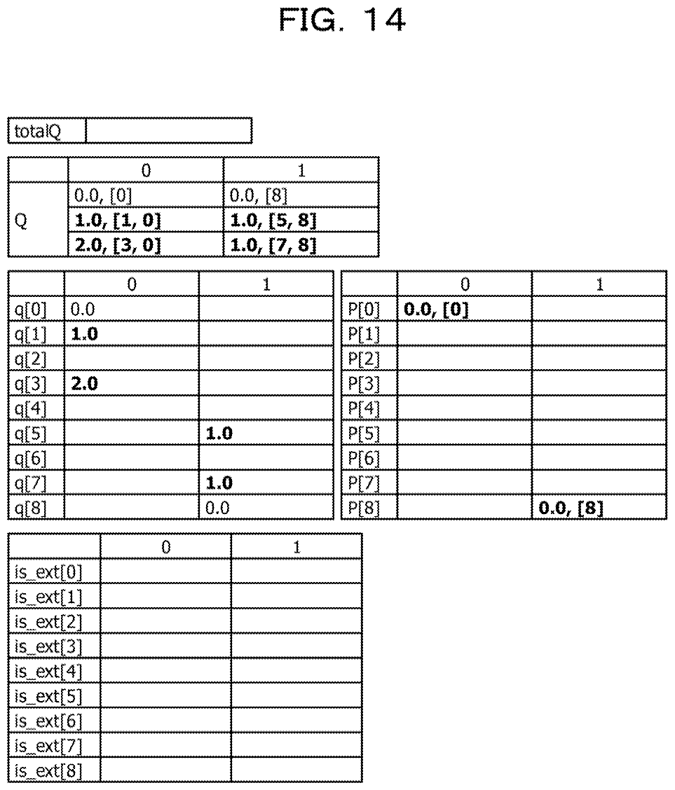

FIG. 13 is a diagram for explaining adjacent vertex processing at a starting point and an end point. FIG. 14 is a diagram for explaining a data structure after the adjacent vertex processing at the starting point and the end point. Processing at the vertex 0 and the vertex 8 and the vertices 1, 3, 5, and 7 adjacent thereto will be described. As illustrated in FIG. 13, the searching unit 22 performs path searches on the vertices 1 and 3 adjacent to the vertex 0 on the starting point side and the vertices 5 and 7 adjacent to the vertex 8 on the end point side, The results are stored in the data structures illustrated in FIG. 14.

First, searching processing on the starting point side is executed. As illustrated in FIG. 13, the searching unit 22 performs the processing on the vertex 1 of the vertices 1 and 3 adjacent to the vertex 0 being the starting point. Though the vertex 3 may be processed first, vertices are basically to be processed in the order of storage in the list “v.adj_edge_list( )”. The following description assumes that vertices are stored in the list in the order of the vertex numbers. More specifically, for example, the searching unit 22 takes out [0.0,[0]] from the starting point side priority queue Q[0] and stores it in P[0][0]. Next, the searching unit 22 identifies the length “1.0” from the vertex 0 to the vertex 1. Because the number of paths stored in q[1][0] of the vertex 1 is lower than pₘₐₓ (=1), “1.0” is stored in q[1][0]. The searching unit 22 stores [1.0,[1,0]] as path information [length, path=[vertex, vertex]] from the starting point to the vertex 1 in the starting point side priority queue Q[0].

Also, the searching unit 22 identifies the length “2.0” from the vertex 0 to the vertex 3. Because the number of paths stored in q[3][0] of the vertex 3 is lower than pₘₐₓ (=1), “2.0” is stored in q[3][0]. The searching unit 22 stores [2.0,[3,0]] as path information [length, path=[vertex, vertex]] from the starting point to the vertex 3 in the starting point side priority queue Q[0].

Next, searching processing on the end point side is executed. As illustrated in FIG. 13, the searching unit 22 executes the same processing as the processing executed on the vertex 0 on the vertex 8 being the end point so that [0.0,[8]] is taken out from the end point side priority queue Q[1] and stores [0.0,[8]] in the list P[8][1] corresponding to the vertex 8 to be processed. The searching unit 22 stores [1.0] in the list q[5][1] of the vertex 5 adjacent to the vertex 8 and stores [1.0] in the list q[7][1] of the vertex 7 adjacent to the vertex 8. The searching unit 22 stores path information [1.0,[5,8] from the end point to the vertex 5 and path information [1.0,[7,8] from the end point to the vertex 7 in the end point side priority queue Q[1].

This processing will be described in more detail. Because Q[0] and Q[1] are not empty, the condition in S11 in FIG. 8 is satisfied. Therefore, the searching unit 22 first executes “i=0” in S13. Next, because S14 is satisfied, Q[0] is not empty. Therefore, the searching unit 22 executes the processing in S17 and takes out [path_length_v,path_v]=[0,0,[0]] from Q[0]. In other words, for example, path_length_v=0,0, path_v=[0] are set. In a case where the vertex having a vertex identifier i is vᵢ, path_v=[v₀] is simplified, Because of v path_v[0]. v=0 is set.

Next, the searching unit 22 in S18 invokes the function is_extended( ) that determines whether the processing of extending v in S19 and subsequent steps is to be performed or not. Because S312 and S313 in FIG. 11 are satisfied at least at the initial state, the searching unit 22 executes S314. However, because not one shortest path is found, the searching unit 22 in S313 returns the processing with r=True set in S311. In other words, for example, the searching unit 22 determines to perform the extension processing and executes S19 in FIG. 8.

After that. the searching unit 22 determines the condition for determining whether the vertex v is a joint point or not in S21 in FIG. 9 is not satisfied, executes S23, and adds [0,0,[0]] to P[0][0]. Because the vertex v is not a joint point, the expression in S24 is not satisfied. Therefore, the vertex adjacent processing in S26 is executed.

Because [1,1,0] and [3,2.0] are remained as being unprocessed in S31, the searching unit 22 first selects [1,1.0] as [w,edge_length] and executes S32. Next, the searching unit 22 determines the condition in S32 is satisfied. Because w=1 is not included in path_v=[0], the searching unit 22 executes S34. Because path_length_v=0.0 and edge_length=1.0, the path length path_length_w to the vertex w is calculated as “1.0”. After that, though the searching unit 22 stores path_length_w in the list q[0][0] in S35, the lust is still empty. Therefore, the condition in S35 is satisfied, and S36 is executed. path_w=[w,path_v] is defined, and [path_length_w,path_w], that is, [1.0,[1,0]] is stored in Q[0].

The searching unit 22 also executes the same calculations on the unprocessed [3,2.0] and stores [2.0,[3,0]] in Q[0]. When this processing ends, the values are set at the columns of “0” at Q, q[1], q[3], and P[0] as illustrated in FIG. 14. There is not vertex whose extension is stopped, is_extended_list does not change from the initial state.

Up to this point, the adjacent vertex processing for v ends, and the extension processing for v ends. Returning to S16 in FIG. 8, i=1. Then, the processing on the end point side in S14 and subsequent steps is executed. As a result, as illustrated in FIG. 14, values are set at the columns of 1 of Q, q[1], q[3], and P[0]. In other words, for example, [1.0,[5,8]] and [1.0,[7,8]] are stored in at Q[1], 1.0 is stored at q[5][1] and q[7][1], and [0,0,[8]] is stored at P[8][1].

FIG. 14 only illustrates states of data structures at the time when all adjacent vertex processing ends on the starting point side and the end point side and does not illustrate data structures while the aforementioned processing is being executed. For example, when the processing on the starting point side ends, the settings on the end point side as illustrated in FIG. 14 have not been given. This is also true in the subsequent drawings. Referring to FIG. 14, the light characters correspond to a deleted part, and the bold characters correspond to a newly set part. The queues are priority queues. Therefore, lengths are sorted in increasing order in the queues.

### Adjacent Vertex Processing: Part 1

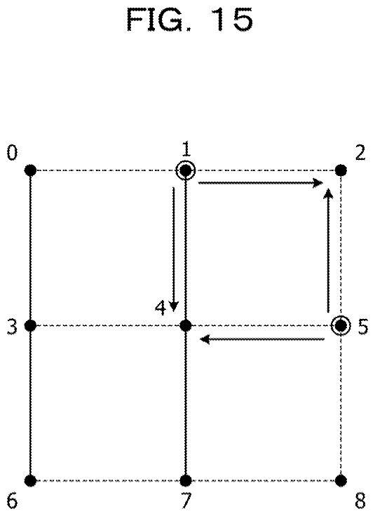

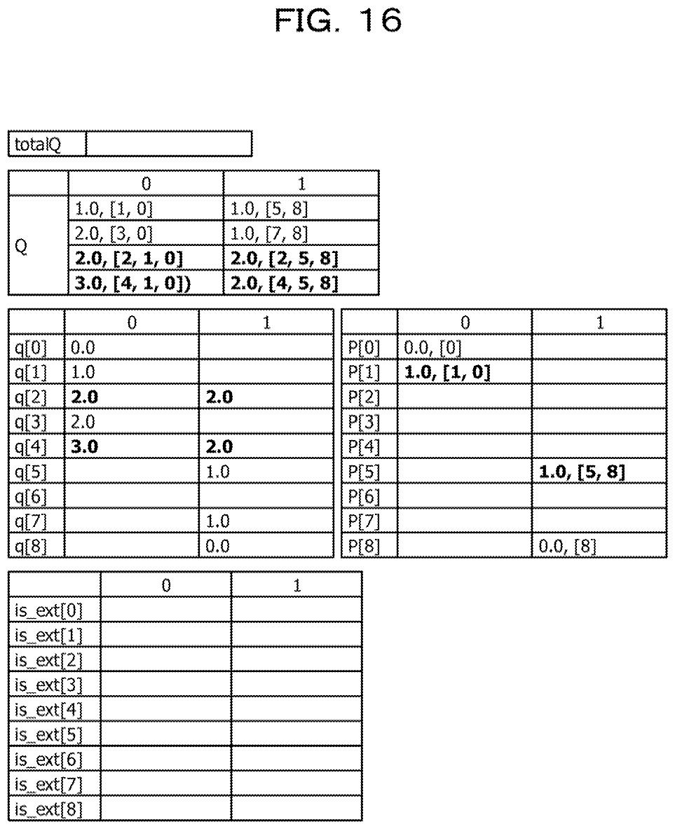

FIG. 15 is a diagram for explaining adjacent vertex processing at the vertex 1 and the vertex 5. FIG. 16 is a diagram for explaining data structures after the adjacent vertex processing at the vertex 1 and the vertex 5. Path information [1.0,[1,0]] regarding the vertex 1 is taken out as information to be stored at the beginning from Q[0], and path information [1.0,[5,8]] regarding the vertex 5 is taken out as information to be stored at the beginning from Q[1]. Therefore, the vertex 1 is to be processed from the starting point side, and the vertex 5 is to be processed from the end point side.

More specifically, for example, as illustrated in FIG. 15, the searching unit 22 executes path searches for the vertex 2 and the vertex 4 adjacent to the vertex 1 on the searched starting point side and the vertex 2 and the vertex 4 adjacent to the vertex 5 on the searched end point side. The results are stored in the data structures illustrated in FIG. 16. The searching unit 22 also performs the same processing on from the vertex 1 to the vertex 0. However, the vertex 0 is a vertex that has been passed already, it is not to be stored. The same is true for the vertex 8.

First, searching processing on the starting point side is executed. As illustrated in FIG. 15, the searching unit 22 executes processing on the vertex 2 between the vertices 2 and 4 adjacent to the vertex 1 to be processed. More specifically, for example, as illustrated in FIG. 16, the searching unit 22 takes out [1.0,[1,0]] from the starting point side priority queue Q[0] and stores it in P[1][0] corresponding to the vertex 1 to be processed. Next, as a path (length) from the starting point to the vertex 2, the searching unit 22 calculates a length “2.0” acquired by adding the length “1.0” from the vertex 0 to the vertex 1 and the length “1.0” from the vertex 1 to the vertex 2. Because the number of paths stored in q[2][0] of the vertex 2 is lower than pₘₐₓ (=1), the searching unit 22 stores “2.0” in q[2][0]. The searching unit 22 stores [2.0,[2,1,0]] as path information [length, path] to the vertex 2 in the starting point side priority queue Q[0].

Also, as illustrated in FIG. 15, the searching unit 22 identifies the length “3.0” from the vertex 0 being the starting point to the vertex 4. Because the number of paths stored in q[4][0] of the vertex 4 is lower than pₘₐₓ (=1), “3.0” is stored in q[4][0] as illustrated in FIG. 16. The searching unit 22 stores [3.0,[4,1,0]] as path information [length, path] to the vertex 4 in the starting point side priority queue Q[0].

Next, searching processing on the end point side is executed. As illustrated in FIG. 15, the searching unit 22 executes the same processing as the processing executed on the vertex 1 on the vertex 5 on the end point side so that the searching unit 22 takes out [1.0,[5,8]] from the end point side priority queue Q[1] and stores [1.0,[5,8]] in P[5][1] corresponding to the vertex 5 to be processed. The searching unit 22 calculates a length “1.0+1.0=2.0” from the vertex 8 being the end point to the vertex 2 and stores [2.0] in q[2][1]. The searching unit 22 calculates a length “1.0+1.0=2.0” from the vertex 8 being the end point to the vertex 4 and stores [2.0] in q[4][1]. The searching unit 22 stores path information [2.0,[2,5,8] from the end point 8 to the vertex 2 and path information [2.0,[4,5,8] from the end point 8 to the vertex 4 in the end point side priority queue Q[1].

This processing will be described in more detail. First, the searching unit 22 takes out [1.0,[1,0]] at the beginning of Q[0] and [1.0,[5,8]] in Q[1] and executes the same processing as the processing described with reference to FIGS. 13 and 14. The searching unit 22 executes the processing on [0,1.0] as [w,edge_length] for the vertex 0, that is, w=0, edge length=1.0 because it is unprocessed. However, because w=0 is the starting point and is a vertex which has been passed already and is included in path_v=[1,0], the searching unit 22 excludes it from the processing targets. The vertex 8 is also excluded from the processing targets, FIG. 15 does not illustrate that kind of vertices, and subsequent drawings also do not illustrate them.

Because paths reaches the vertex 2 and the vertex 4 from both of the starting point to the end point, it appears that a shortest path from the starting point to the end point is formed by jointing them. However, it is not trues Certainly, paths from the starting point and the end point to the vertex 2 and the vertex 4 are stored in the queues Q[0] and Q[1] as shortest path candidates, but they are only candidates. When they are taken out from the queue, the partial shortest path from the starting point or end point to the vertex is fixed among all candidates that are not taken out (including those that have not been put into the queue). In other words, for example, if the shortest path to the vertex has not been taken out, the taken path is guaranteed as a shortest path from the starting point or the end point to the vertex. When i paths have already reached, it is guaranteed to be the (i+1)th shortest path. Conversely, even when candidates stored in the queues Q[0] and Q[1] are jointed, it is not clear which ones are jointed.

### Adjacent Vertex Processing: Part 2

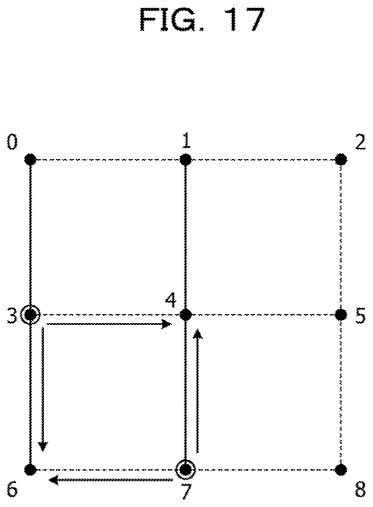

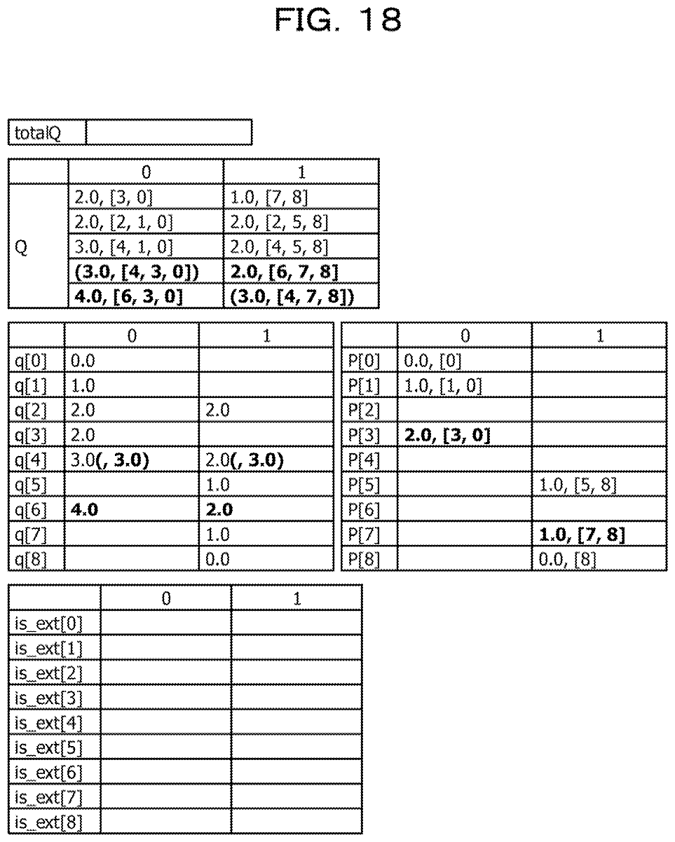

FIG. 17 is a diagram for explaining adjacent vertex processing at the vertex 3 and the vertex 7. FIG. 18 is a diagram for explaining data structures after the adjacent vertex processing at the vertex 3 and the vertex 7. Path information [2.0,[3,0]] regarding the vertex 3 is taken out as information to be stored at the beginning from Q[0], and path information [1.0,[7,8]] regarding the vertex 7 is taken out as information to be stored at the beginning from Q[1]. Therefore, the vertex 3 is to be processed from the starting point side, and the vertex 7 is to be processed from the end point side.

More specifically, for example, as illustrated in FIG. 17, the searching unit 22 executes path searches for the vertex 4 and the vertex 6 adjacent to the vertex 3 on the searched starting point side and the vertex 4 and the vertex 6 adjacent to the vertex 7 on the searched end point side. The results are stored in the data structures illustrated in FIG. 18. Because the vertex 0 and the vertex 8 are vertices that have been passed already, the searching unit 22 determines that they are excluded from the processing targets.

First, searching processing on the starting point side is executed. As illustrated in FIG. 17, the searching unit 22 executes processing on the vertex 4 between the vertices 4 and 6 adjacent to the vertex 3 to be processed. More specifically, for example, as illustrated in FIG. 18, the searching unit 22 takes out [2,0,[3,0]] to be stored at the beginning from the starting point side priority queue Q[0] and stores it in P[3][0] corresponding to the vertex 3 to be processed. Next, as a path (length) from the starting point to the vertex 4, the searching unit 22 calculates a total length “3.0” acquired by adding the length “2.0” from the vertex 0 to the vertex 3 and the length “1.0” from the vertex 3 to the vertex 4. The searching unit 22 tries to store the total length “3.0” in q[4][0] of the vertex 4. However, “3.0” has already been stored in q[4][0], the condition that the number of stored paths is lower than pₘₐₓ is not satisfied, and the stored length is equal to or lower than the calculated length, Therefore, the searching unit 22 abandons the total length without storing it. As a result, the searching unit 22 does not store the path information [3.0,[4,3,0]] to the vertex 4 in the starting point side priority queue Q[0].

Also, as illustrated in FIG. 17, the searching unit 22 identifies the length “4.0” from the vertex 0 being the starting point to the vertex 6. Because the number of paths stored in q[6][0] of the vertex 6 is lower than pₘₐₓ (=1), “4.0” is stored in q[6][0] as illustrated in FIG. 17. The searching unit 22 stores [4.0,[6,3,0]] as path information [length, path] in the starting point side priority queue Q[0].

Next, searching processing on the end point side is executed. As illustrated in FIG. 17, the searching unit 22 executes the same processing as the processing executed on the vertex 3 on the vertex 7 on the end point side so that the searching unit 22 takes out [1.0,[7,8]] at the beginning from the end point side priority queue Q[1] and stores [1.0,[7,8]] in P[7][1] corresponding to the vertex 7 to be processed. As a path (length) from the end point to the vertex 6 adjacent to the vertex 7, the searching unit 22 calculates a total length “2.0” acquired by adding the length “1.0” from the vertex 8 to the vertex 7 and the length “1.0” from the vertex 7 to the vertex 6. Because the number of paths stored in q[6][1] of the vertex 6 is lower than pₘₐₓ (=1), the searching unit 22 stores “2.0” in q[6][1]. The searching unit 22 stores [2.0,[6,7,8]] as path information [length,path] to the vertex 6 in the starting point side priority queue Q[0].

Also for the vertex 4 adjacent to the vertex 7, as a path (length) from the end point to the vertex 4, the searching unit 22 calculates a total length “3.0” acquired by adding the length “1.0” from the vertex 8 to the vertex 7 and the length “2.0” from the vertex 7 to the vertex 4. The searching unit 22 tries to store the total length “3.0” in q[4][1] of the vertex 4. However, “2.0” has already been stored in q[4][1], the condition that the number of stored paths is lower than pₘₐₓ is not satisfied, and the stored length is equal to or lower than the calculated length. Therefore, the searching unit 22 abandons the total length without storing it. As a result, the searching unit 22 does not store the path information [3.0,[4,7,8]] to the vertex 4 in the starting point side priority queue Q[1].

This processing will be described in more detail. The adjacent vertex processing is performed on the vertex 3 and the vertex 7 so that the data structures in FIG, 18 may be acquired. In the adjacent vertex processing from the vertex 3 to the vertex 4 in the processing, [w,edge_length]=[4,1.0] is processed in S31 in FIG. 10. However, path_length=3.0 is calculated in S34, but 3.0 has been already stored in q[4][0], and pₘₐₓ=1. It is not stored in q in S35 even if the storage is tried. In that case, because the value of “q[v.id( )][i].enque(path_length_w)” is “False”, the storage in the queue Q in S36 is not performed. This is the effect of reduction of unnecessary candidates with q. Referring to FIG. 18, 3.0 in q[4][0] is enclosed in a round bracket to indicate that the storage of the value is failed. “3.0,[4,3,0]” and “3.0,[4,7,8]” enclosed in round brackets in Q[0] and Q[1] indicate that they are stored if the reduction effect with q is not applied though the storage is not failed. Hereinafter, this notation is used in other data structures. The same is true for the adjacent vertex processing from the vertex 7 to the vertex 4 on the end point side.

### Adjacent Vertex Processing: Part 3

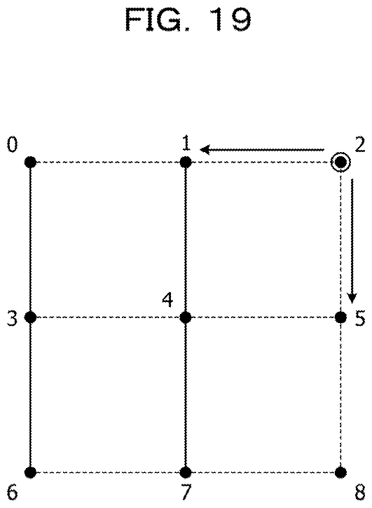

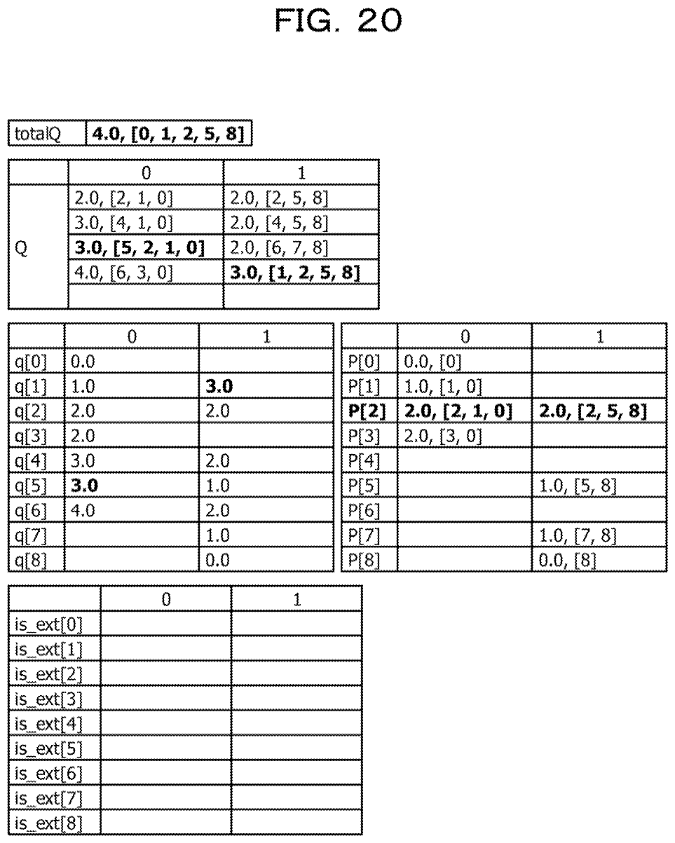

FIG. 19 is a diagram for explaining adjacent vertex processing at the vertex 2. FIG, 20 is a diagram for explaining data structures after the adjacent vertex processing at the vertex 2. Path information [2.0,[2,1,0]] regarding the vertex 2 is taken out as information to be stored at the beginning from Q[0], and path information [2.0,[2,5,8]] regarding the vertex 2 is taken out as information to be stored at the beginning from Q[1]. Therefore, the vertex 2 is to be processed commonly from the starting point side and the end point side. More specifically, for example, as illustrated in FIG. 19, the searching unit 22 executes path searches for the vertex 1 from the starting point side and the vertex 5 from the end point side adjacent to the vertex 2 that has been searched. The results are stored in the data structures illustrated in FIG. 20. Because the vertex 1 from the starting point side and the vertex 5 from the end point side have already been searched, they are to be processed.

First, as illustrated in FIG. 19, the searching unit 22 executes processing on the vertex 5 adjacent to the vertex 2 to be processed. More specifically, for example, as illustrated in FIG. 20, the searching unit 22 takes out [2,0,[2,1,0]] to be stored at the beginning from the starting point side priority queue Q[0] and stores it in P[2][0] corresponding to the vertex 2 to be processed. Next, as a path from the starting point to the vertex 5, the searching unit 22 calculates a total length “3.0” acquired by adding the length “1.0” from the vertex 0 to the vertex 1, the length “1.0” from the vertex 1 to the vertex 2 and the length “1.0” from the vertex 2 to the vertex 5. Because the number of paths stored in q[5][0] of the vertex 5 is lower than pₘₐₓ (=1), the searching unit 22 stores “3.0” in q[5][0]. The searching unit 22 stores [3.0,[5,2,1,0]] as path information to the vertex 5 in the starting point side priority queue Q[0]. It is inserted to the priority queue Q[0] so that the lengths are sorted in increasing order.

The searching unit 22 executes the same processing on the vertex 1 adjacent to the vertex 2 to be processed so that the searching unit 22 takes out [2.0,[2,5,8]] at the beginning from the end point side priority queue “Q[1]” and stores [2.0,[2,5,8]] in P[2][1] corresponding to the vertex 2 to be processed. The searching unit 22 calculates a length “1.0+1.0+1.0=10” from the vertex 8 being the end point to the vertex 1 and stores [3.0] in q[1][1]. The searching unit 22 stores path information [3.0,[1,2,5,8]] from the end point 8 to the vertex 1 in the end point side priority queue Q[1].

Because values are stored in P[2][0] and P[2][1], the searching unit 22 determines that the vertex 2 is a joint point. The searching unit 22 then combines the path [2,1,0] from the starting point to the vertex 2 and the path [2,5,8] from the end point to the vertex 2 to generate a path [0,1,2,5,8]. The searching unit 22 further combines the length “2.0” of the path from the starting point to the vertex 2 and the length [2.0] of the path from the end point to the vertex 2 to calculate the length of the path [0,1,2,5,8] as [4.0]. Because data is not stored in totalQ, the searching unit 22 stores the path information “4.0[0,1,2,5,8]” as a shortest path in totalQ.

This processing will be described in more detail. [2.0,[2,1,0]] is taken out from Q[0], and [2.0,[2,5,8]] is taken out from Q[1]. Therefore, the shortest path from the starting point and the shortest path from the end point are jointed at the vertex 2 for the first time. In other words, the vertex 2 is now a joint point. When i=1 in FIG. 8, that is, when the processing on the end point side is performed, is_joint[2] is acquired in S21 in FIG, 9, [2.0,[2,1,0]] has already been stored in P[2][0], and “0<P[v.id][opp(i)].len( )” is satisfied, Therefore, S22 indicating that the vertex 2 is a joint point is executed. Thus, because S24 is satisfied after S23 is executed, S25 is executed. The partial shortest path [2,1,0] already acquired as P[2][0] from the starting point to the vertex 2 and path_v=[2,5,8] are combined to form a path [0,1,2,5,8] having a length of 4.0 from the starting point to the end point. This acquired path does not include a loop, and totalQ is empty at this time and apparently does not include the same path. A path may be stored in totalQ because totalQ is empty. Therefore, [4.0,[0,1,2,5,8]] is stored in totalQ. This means that the (first) shortest path from the starting point to the end point is stored in totalQ. As described above, P[2] is in boldface type in FIG. 20 to indicate that the vertex 2 is a joint point.

### Adjacent Vertex Processing: Part 4

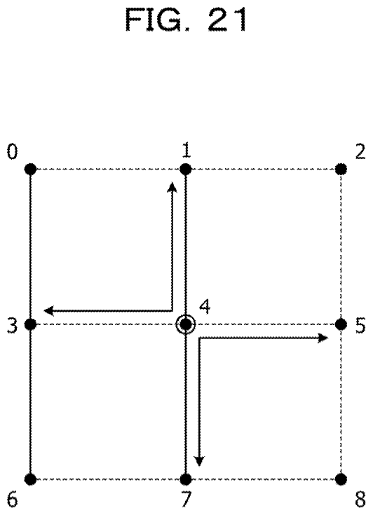

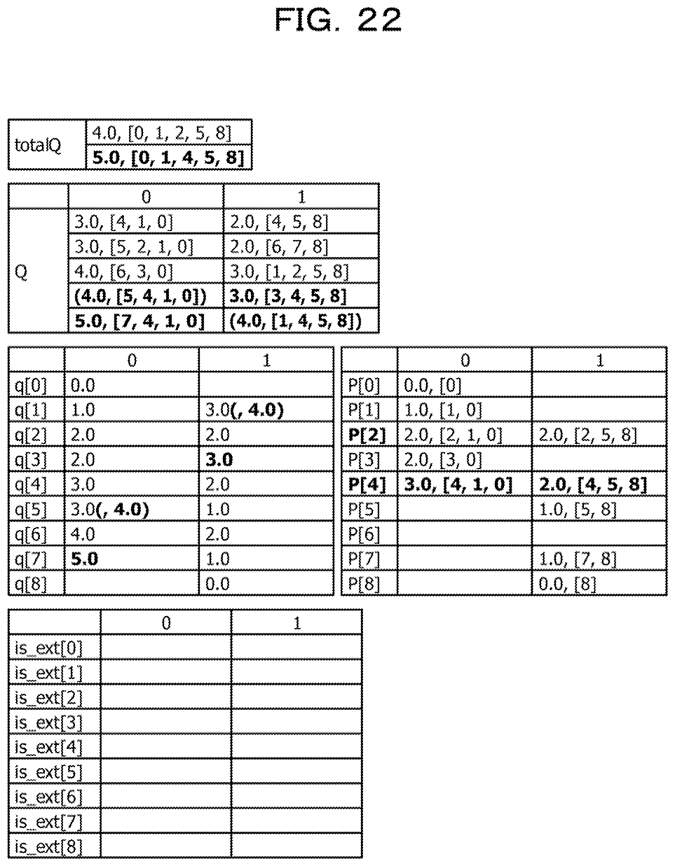

FIG. 21 is a diagram for explaining adjacent vertex processing at a vertex 4. FIG. 22 is a diagram for explaining data structures after the adjacent vertex processing at the vertex 4. Path information [3.0,[4,1,0]] regarding the vertex 4 is taken out as information to be stored at the beginning from Q[0], and path information [2.0,[4,5,8]] regarding the vertex 4 is taken out as information to be stored at the beginning from Q[1]. Therefore, the vertex 4 is to be processed commonly from the starting point side and the end point side. More specifically, for example, as illustrated in FIG. 21, the searching unit 22 executes path searches for the vertex 5, the vertex 7, the vertex 1, and the vertex 3 adjacent to the vertex 4 that has been searched. The results are stored in the data structures illustrated in FIG. 22.

First, searching processing on the starting point side is executed. As illustrated in FIG. 21, the searching unit 22 executes processing on the vertex 5 between the vertices 5 and 7 adjacent to the vertex 4 to be processed. More specifically, for example, as illustrated in FIG. 22, the searching unit 22 takes out [3.0,[4,1,0]] from the beginning of the starting point side priority queue Q[0] and stores it in P[4][0] corresponding to the vertex 4 to be processed. Next, the searching unit 22 calculates a total of “4.0” of the lengths of the path formed by the vertex 0, the vertex 1, the vertex 4, and the vertex 5 as a path from the starting point to the vertex 5. The searching unit 22 tries to store the length “4.0” in q[5][0] of the vertex 5. However, “3.0” has already been stored in q[5][0], the condition that the number of stored paths is lower than pₘₐₓ is not satisfied, and the stored length is equal to or lower than the calculated length.

Therefore, the searching unit 22 abandons the total length without storing it. As a result, the searching unit 22 does not store the path information [4.0,[5,4,1,0]] to the vertex 5 in the starting point side priority queue Q[0].

Also, as illustrated in FIG. 21, the searching unit 22 identifies the length “5.0” from the vertex 0 being the starting point to the vertex 7. Because the number of paths stored in q[7][0] of the vertex 7 is lower than pₘₐₓ (=1), “5.0” is stored in q[7][0] as illustrated in FIG. 22. The searching unit 22 stores [5.0,[7,4,1,0]] as path information in the starting point side priority queue Q[0].

Next, searching processing on the end point side is executed. As illustrated in FIG. 21, the searching unit 22 executes the same processing on the vertex 1 on the end point side so that the searching unit 22 takes out [2,0,[4,5,8]] from the end point side priority queue “Q[1]” and stores [2,0,[4,5,8]] in P[4][1] corresponding to the vertex 4 to be processed. The searching unit 22 identifies the length “3.0” from the vertex 8 being the end point to the vertex 3. Because the number of paths stored in q[3][1] of the vertex 3 is lower than pₘₐₓ (=1), “10” is stored in q[3][1] as illustrated in FIG. 22. The searching unit 22 stores [3.0,[3,4,5,8]] as path information in the end point side priority queue Q[1].

The searching unit 22 also executes the same processing on the vertex 1 on the end point side and calculates a total of “4.0” of the length of the path via the vertex 8, the vertex 5, the vertex 4, and the vertex 1 as a path (length) from the end point to the vertex 1. The searching unit 22 tries to store the length “4.0” in q[1][1] of the vertex 1. However, “3.0” has already been stored in q[1][1], the condition that the number of stored paths is lower than pₘₐₓ is not satisfied, and the stored length is equal to or lower than the calculated length. Therefore, the searching unit 22 abandons the total length without storing it. As a result, the searching unit 22 does not store the path information [4.0,[1,4,5,8]] to the vertex 1 in the end point side priority queue Q[1].

Because values are stored in P[4][0] and P[4][1], the searching unit 22 determines that the vertex 4 is a joint point. The searching unit 22 then combines the path [4,1,0] from the starting point to the vertex 4 and the path [4,5,8] from the end point to the vertex 4 to generate a path [0,1,4,5,8]. The searching unit 22 further combines the length “3.0” of the path from the starting point to the vertex 4 and the length [2.0] of the path from the end point to the vertex 4 to calculate the length of the path [0,1,4,5,8] as [5.0]. Because data to be stored in totalQ is lower than 2 (=k), the searching unit 22 stores the path information “5.0[0,1,4,5,8]” as a shortest path in totalQ.

By executing the aforementioned processing, the adjacent vertex processing illustrated in FIG. 21 is performed at the vertex 4, and the data structures illustrated in FIG. 22 are acquired. It is noted that totalQ is full. Hereinafter, with the fact, the reduction effect of the processing in S314 and subsequent steps in FIG. 11 may be expected, Also, the reduction effect with q also appears.

### Adjacent Vertex Processing: Part 5

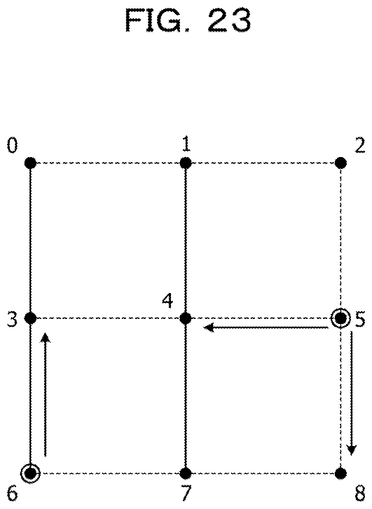

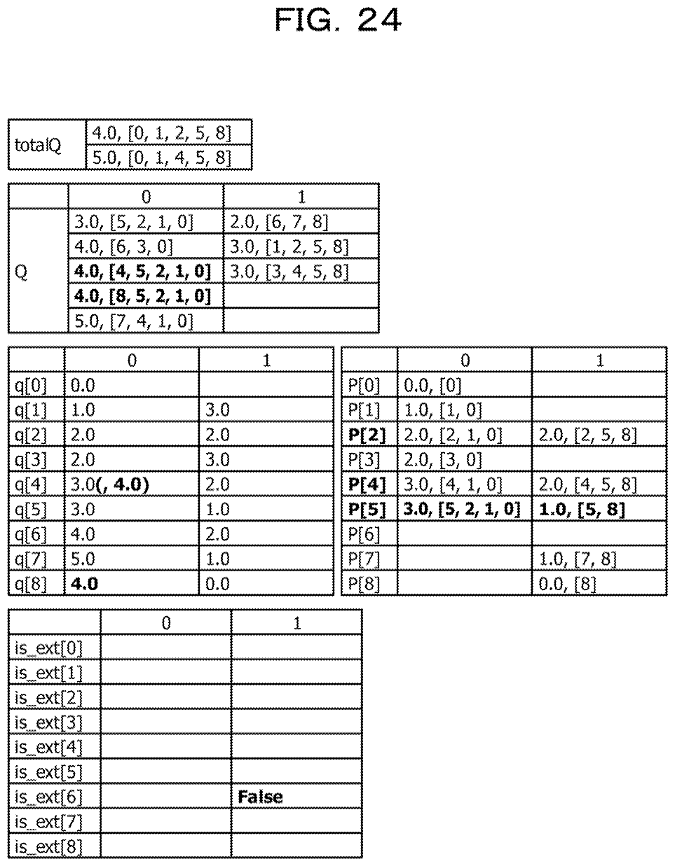

FIG. 23 is a diagram for explaining adjacent vertex processing at the vertex 5 and the vertex 6. FIG. 24 is a diagram for explaining data structures after the adjacent vertex processing at the vertex 5 and the vertex 6. Path information [3.0,[5,2,1,0]] regarding the vertex 5 is taken out as information to be stored at the beginning from Q[0], and path information [2.0,[6,7,8]] regarding the vertex 6 is taken out as information to be stored at the beginning from Q[1], Therefore, the vertex 5 and the vertex 6 are to be processed.

More specifically, for example, as illustrated in FIG. 23, the searching unit 22 executes path searches for the vertex 4 and the vertex 8 adjacent to the vertex 5 that has been searched and the vertex 3 adjacent to the vertex 6 that has been searched. The results are stored in the data structures illustrated in FIG. 24. Because the vertex 7 has been searched by the search from the vertex 8 being the end point, the vertex 7 is excluded from the processing targets.

First, searching processing on the starting point side is executed. As illustrated in FIG. 23, the searching unit 22 executes processing on the vertex 4 between the vertices 4 and 8 adjacent to the vertex 5 to be processed. More specifically, for example, as illustrated in FIG. 24, the searching unit 22 takes out [3,0,[5,2,1,0]] from the beginning of the starting point side priority queue Q[0] and stores it in P[5][0] corresponding to the vertex 5 to be processed. Next, the searching unit 22 calculates a total of “4.0” of the lengths of the path formed by the vertex 0, the vertex 1, the vertex 2, the vertex 5, and the vertex 4 as a path from the starting point to the vertex 4. The searching unit 22 tries to store the length “4.0” in q[4][0] of the vertex 4. However, “3.0” has already been stored in q[4][0], the condition that the number of stored paths is lower than pₘₐₓ is not satisfied, and the stored length is equal to or lower than the calculated length. Therefore, the searching unit 22 abandons the total length without storing it. As a result, the searching unit 22 does not store the path information [4,0,[4,5,2,1,0]] to the vertex 4 in the starting point side priority queue Q[0],

Also, as illustrated in FIG. 23, the searching unit 22 executes the same processing on the vertex 8. More specifically, for example, the searching unit 22 identifies the length “4.0” from the vertex 0 being the starting point to the vertex 8. Because the number of paths stored in q[8][0] of the vertex 8 is lower than pₘₐₓ (=1), “4.0” is stored in q[8][0] as illustrated in FIG. 24. The searching unit 22 stores [4.0,[8,5,2,1,0]] as path information in the starting point side priority queue Q[0].

Next, searching processing on the end point side is executed. As illustrated in FIG. 23, the searching unit 22 executes the same processing also on the vertex 3 adjacent to the vertex 6 being the end point in the cases up to this point. However, it is determined by the extension determination processing in FIG. 11 that the search is not extended because of the reduction effect by max, and therefore the processing is not required to be performed, as will be described in detail below.

Because values are stored in P[5][0] and P[5][1], the searching unit 22 determines that the vertex 5 is a joint point. The searching unit 22 then combines the path [5,2,1,0] from the starting point to the vertex 5 and the path [5,8] from the end point to the vertex 5 to generate a path [0,1,2,5,8]. The searching unit 22 further combines the length “3.0” of the path from the starting point to the vertex 5 and the length [1,0] of the path from the end point to the vertex 5 to calculate the length of the path [0,1,2,5,8] as [4.0]. The searching unit 22 tries to store the path information [4.0,[0,1,2,5,8]] in totalQ. However, because it has been already stored, the path information is abandoned.

This processing will be described in more detail. When the adjacent vertex processing is executed on the vertex 5 and the vertex 6 as before, the adjacent vertex processing is not performed on the vertex 6. As a result, the data structures illustrated in FIG. 24 are acquired. This is because of the reduction effect as described above. More specifically, for example, whether the extension processing at the vertex 6 is to be performed is determined by following the flowchart in FIG. 11. If the condition in S314 is satisfied, S315 is executed. If the condition is not satisfied, S316 is executed. In order to satisfy the condition, min=4.0 is set in S319. As a result, path_length+min=2.0+4.0 is acquired in S320 while the condition is not satisfied because max=5.0. Therefore, S321 is executed. Because is_v is True, False is set to is_extended_list[x.id( )][i], more specifically, is_extended_list[6][1], because of S317 for the first time here, r=False is set in S322, and r=False is the return value, In other words, for example, the extension processing of v is not performed.

### Adjacent Vertex Processing: Part 6

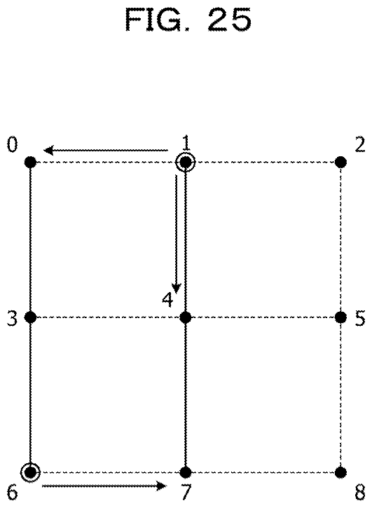

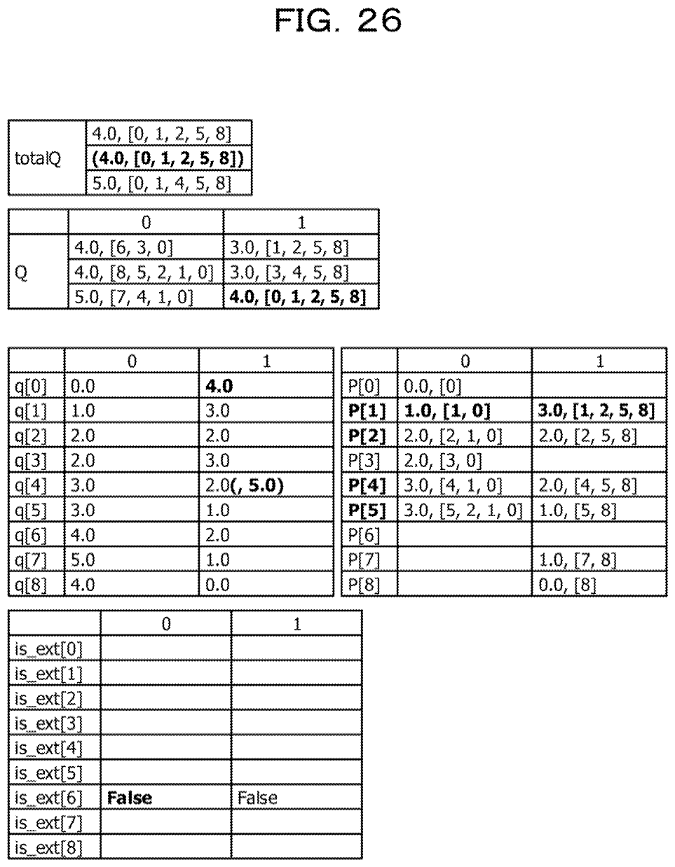

FIG. 25 is a diagram for explaining adjacent vertex processing at the vertex 6 and a vertex 1, FIG. 26 is a diagram for explaining data structures after the adjacent vertex processing at the vertex 6 and the vertex 1. Path information [4.0,[6,3,0]] regarding the vertex 6 is taken out as information to be stored at the beginning from Q[0], and path information [3.0,[1,2,5,8]] regarding the vertex 1 is taken out as information to be stored at the beginning from Q[1], Therefore, the vertex 6 is to be processed on the starting point side, and the vertex 1 is to be processed on the end point side.

More specifically, for example, as illustrated in FIG. 25, the searching unit 22 executes path searches for the vertex 7 adjacent to the vertex 6 that has been searched and the vertex 0 and the vertex 4 adjacent to the vertex 1 that has been searched. The results are stored in the data structures illustrated in FIG. 26. Because the vertex 3 from the starting point side and the vertex 2 from the end point side have already been searched, they are not to be processed.

First, searching processing on the starting point side is executed. As illustrated in FIG. 25, the searching unit 22 is to execute processing on the vertex 7 adjacent to the vertex 6 to be processed. However, like the previous case, it is determined by the extension determination processing in FIG. 11 that the search is not extended because of the reduction effect by max, and therefore the processing is not required to be performed, as will be described in detail below.

Next, searching processing on the end point side is executed. As illustrated in FIG. 25, the searching unit 22 executes the same processing also on the vertex 0 adjacent to the vertex 1 being the end point. More specifically, for example, the searching unit 22 takes out [3.0,[1,2,5,8]] from the end point side priority queue Q[1] and stores [3.0,[1,2,5,8] in P[1][1] corresponding to the vertex 1 to be processed. The searching unit 22 calculates a total of “4.0” of the lengths of the path via the vertex 8, the vertex 5, the vertex 2, the vertex 1, and the vertex 0 as a path (length) from the end point to the vertex 0. The searching unit 22 then stores the length “4.0” to q[0][1] of the vertex 1. The searching unit 22 stores the path information [4.0,[0,1,2,5,8]] to the vertex 0 in the end point side priority queue Q[1].

Regarding the vertex 4 adjacent to the vertex 1, because the path having a length of 2 has already reached from the end point to the vertex 4 (q[4][1]=[2.0]), the processing is ended.

By performing the aforementioned processing, the adjacent vertex processing is executed on the vertex 6 and the vertex 1. The processing is performed on the vertex 1 as before, but the adjacent vertex processing is not performed on the vertex 6. As a result, the data structures illustrated in FIG. 26 are acquired. More specifically, for example, whether the extension processing at the vertex 6 is to be performed is determined by following the flowchart in FIG. 11, Because the condition in S314 is satisfied, S315 is executed. However, because the condition is not satisfied, S316 is executed. Because the condition in S316 is satisfied, S319 is executed, and min=3.0 is set. As a result, path_length+min=4.0+3.0=7.0 is acquired in S320 while the condition is not satisfied because max=5.0. Therefore, S321 is executed. Because is_v is True, S317 is executed, and False is set for is_extended_list[6][0]. r=False is set in S322, and r=False is the return value, Though the vertex 1 newly becomes a joint point, the path “4.0,[0,1,2,5,8]” generated by jointing paths there is already in totalQ. Therefore, the path is not stored in totalQ because of the operation of S25 in FIG. 9.

This processing continues also after this, However, the storage in Q[0] and Q[1] is suspended, and both of Q[0] and Q[1] become empty. At that time, based on the condition in S11 in FIG. 8, the processing ends. The paths remaining in totalQ at that time are k-shortest paths to be acquired.

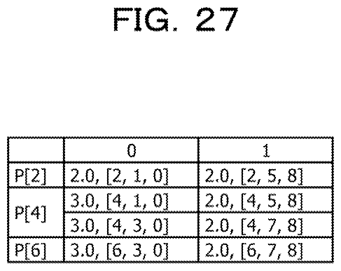

Based on the descriptions above, an overview of the acquisition of a shortest path through combination of partial shortest paths at joint points will be described with reference to FIG. 27. FIG. 27 is a diagram for explaining partial shortest paths at joint points on a diagonal line. FIG. 27 illustrates final partial shortest paths acquired at vertices (expected to be joint points) on a diagonal line different from a diagonal line coupling a starting point and an end point. From FIG. 27, it is apparent that starting point side (0) partial shortest paths and end point side (1) partial shortest paths are combined at the vertices to acquire all paths illustrated in FIG. 12A. For example, two partial shortest paths on the starting point side and the end point side are combined at the vertex 4 to acquire all shortest paths passing through the vertex 4. However, this applies only in this example. Not all paths are acquired from the starting point to the end point generally. Because acquiring all paths takes time, the processing is ended based on the condition in S11 in FIG. 8.

### Embodiment 3

Next, optimization of the parameter α will be described. The optimization of the parameter α corresponds to a search for an optimum parameter by changing the value of pₘₐₓ in a range from 1 to k within a range equal to or higher than the user acceptable precision Pₘᵢₙ. The inclusion of k guarantees acquisition of the parameter with a precision of 1.0 even when Pₘᵢₙ=1.0 is designated. However, there is a possibility that the processing takes enormous time particularly when the value of pₘₐₓ is close to k during the processing of changing the value pₘₐₓ in a range from 1 to k. This is avoided as follows. Generally, as the value of pₘₐₓ decreases, the searching time decreases,

On the other hand, based on the experiment as will be described below, for example, the precision 1.0 is acquired as a result of reduction of the value of pₘₐₓ. In view of this, pₘₐₓ is started to be changed from 1, and the change is ended when the precision exceeds Pₘᵢₙ. By doing so, it may be expected to perform the optimization at a high speed.

### Flowchart

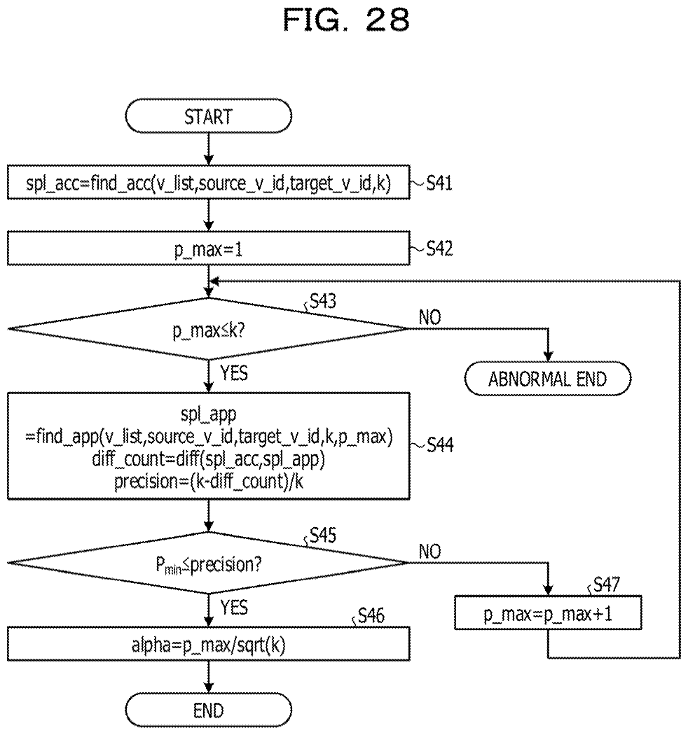

FIG. 28 is a flowchart illustrating a flow of optimization processing to be performed on a parameter α according to Embodiment 3. INFITE represents the highest value among values. Pₘᵢₙ=1.0 is designated for agreement with an accurate solution.

As illustrated in FIG. 28, in S41, find_acc (v_list,source_vid,target_vid,k) is a function that performs precise k-shortest path search and is to be executed. The function find_acc returns spl_acc that is a list of pairs of the length of a shortest path and a vertex array from a starting point to an end point included in the shortest path with parameters of a vertex list v_list, a starting point vertex identifier source_vid, an end point vertex identifier target_vid. and k indicating how many shortest paths are to be acquired in increasing order. acc is short for “accurate” meaning being exact. spl_acc includes lengths of shortest paths sorted in increasing order. This list is called a “shortest path list”. The term “partial shortest path list” has been used in the description above, spl_acc is a list of entire shortest paths.

Next, 1 is substituted for p_max (S42). If p_max is equal to or lower than k (S43: Yes), a function find_app is executed in S44. More specifically, for example, find_app(v_list,source_vid,target_vid,k,p_max) is a function that performs k-shortest path search by approximation. The parameters and return values of the function are similar to those of find_acc, but they are different in that p_max that is a maximum number of paths is added to the parameters. spl_app is a similar list to spl_acc, and they completely agree if calculations go right. However, because spl_app is acquired by approximation, spl_app may not include all of those included in spl_acc. This list is one returned in S12 in FIG. 8 as it is and is also called “shortest path list”, “app” is short for “approximate” meaning being approximate. diff(spl_acc,spl_app) is a function that calculates the number of different shortest paths between two shortest path lists spl_acc and spl_app. If they completely agree, 0 is returned. If d shortest paths are different between them, d is returned,

After that, if precision acquired in S44 is lower than Pₘᵢₙ (S45: No), p_max is incremented (S47), and the processing in S43 and subsequent steps is executed. On the other hand, if precision acquired in S44 is equal to or higher than Pₘᵢₙ (S45: Yes), S46 is executed, and the processing ends. By performing this checking processing up to p_max=k, an accurate solution is acquired without fail even Pₘᵢₙ=1.0 is designated. If α is not acquired even by performing the checking processing up to p_max=k, an error occurs or the processing abnormally ends.

### Result of Optimization of Parameter α

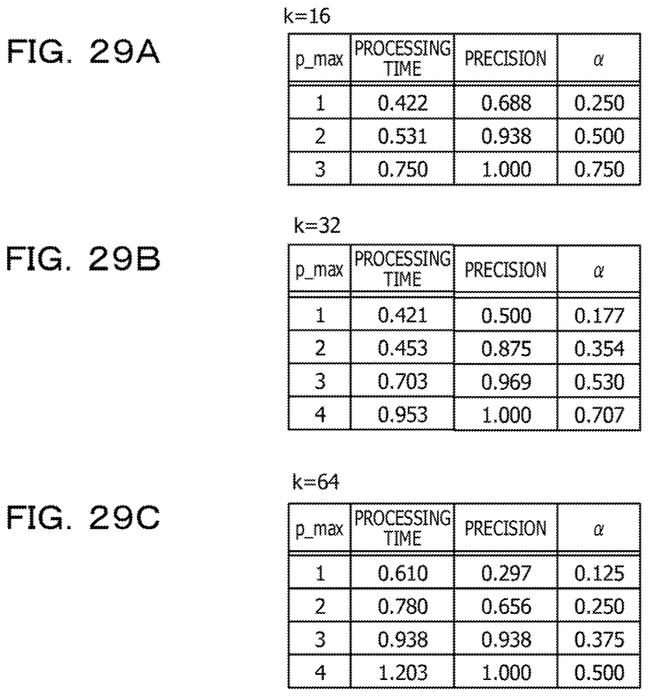

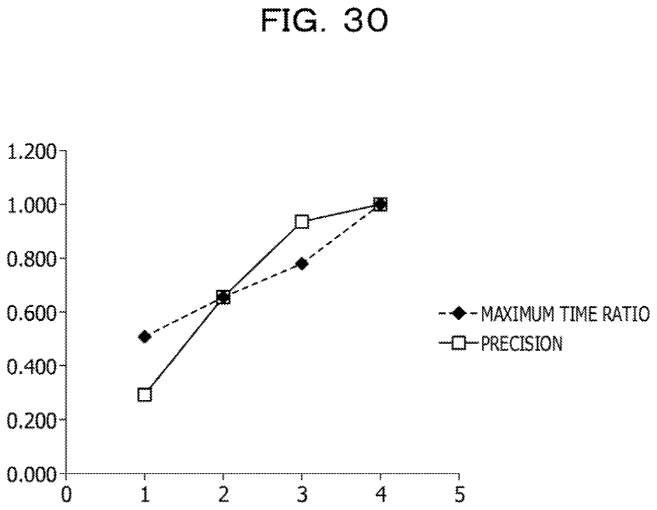

FIG. 29 is a diagram illustrating measurement results of the optimization of the parameter α. FIG. 30 is a diagram illustrating a relationship between pₘₐₓ (horizontal axis) and maximum time ratio or precision (vertical axis). FIG. 29 is a two-dimensional grid graph having 64 steps vertically and horizontally, that is, having n=4096 (64×64) vertices and illustrates results of optimizations when k has values 16, 32, and 64, In this case, Pₘᵢₙ=1.0 for approximation measurement, and the minimum time, that is, the value of pₘₐₓ is incremented as 1, 2, 3 . . . sequentially. The processing time is acquired when the precision satisfies Pₘᵢₙ=1.0. The processing time is a CPU time.

FIG. 30 illustrates a relationship between the processing time and the precision when k=64 of the three values. In order to match the scales of them, the ratio of the processing time to a maximum (or pₘₐₓ=4) processing time is illustrated as a maximum time ratio. For example, the precision is about 0.3 with pₘₐₓ=1 though the processing time is about half of that in the case where pₘₐₓ=4 with a precision of 1.0.

In this example, the processing is ended because a precision of 1.0 is acquired with a significantly low pₘₐₓ. The value of a to be acquired is calculated by using the value of pₘₐₓ when the processing is ended. Against values 16, 32, and 64 of k, the values of a are dose to each other as 0.75, 0.707, and 0.5, respectively. By adopting α=0.75, which is the highest value of the values, it may be expected that the precision is 1.0 or close to that independently of the value of k. If the precision requirement is not so strict, 0.65, which is the average of the values, may be applied. Conversely, if the precision requirement is more strict, the value of α may be higher with a certain margin. For simple description, one measurement is performed on one pair of a starting point and an end point. However, in order to actually determine α, k may be changed in its usable range, and various starting points and end points may be applied to acquire the maximum value or average value of a for effectively performing statistic processing.

### Embodiment 4

Next, effects of the methods according to Embodiments 1 to 3 will be described, Effects by the presence of approximation, reduction effects by max, and a comparison with extended Dijkstra will be described.

### Comparison based on Presence of Approximation

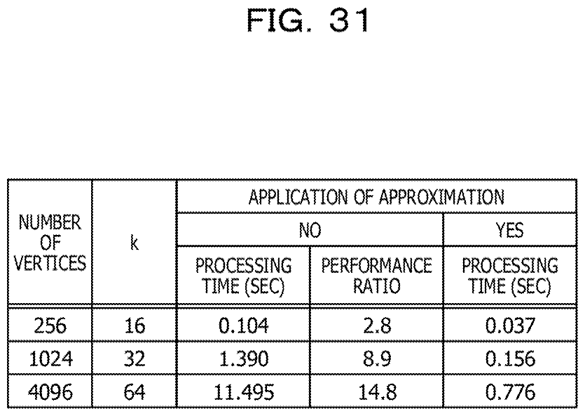

FIG. 31 is a diagram for explaining comparison results based on presence of approximation. The processing times are compared in a case where approximation is used or pₘₐₓ<k and in a case where an accurate solution is acquired without using approximation or pₘₐₓ=k. For the approximation, a result with Pₘᵢₙ=1.0 by the optimization illustrated in FIG. 30 is used. In other words, for example, it is approximation with a precision of 1.0. The minimum processing time is acquired with a precision of Pₘᵢₙ=1.0 by incrementing the value of pₘₐₓ as 1, 2, 3 . . . sequentially, as illustrated in FIG. 31 This is for clearly indicating the significant meaning of the measurement values by approximation. Therefore, the time for the processing may be reduced though the precision is not 1.0.

FIG. 31 illustrates a summary of measurement results by the processing described above. The performance ratio indicates a ratio of processing time when approximation is not used against the processing time of approximation. In other words, for example, the performance ratio indicates how many times the processing speed increases by using approximation. From the results illustrated in FIG. 31, by using approximation, the processing speed was increased by 2.8 to 14.8 times. As the number of vertices increases, the performance ratio increases.

### Reduction Effect by Max

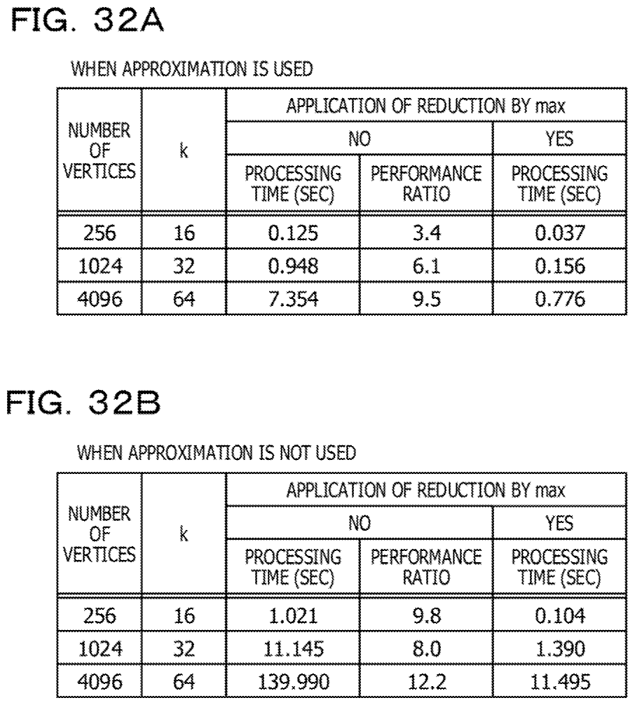

FIGS. 32A and 32B are diagrams for explaining a reduction effect by max. The processing times are compared between a case where reduction by max is used, that is, the processing in S314 and subsequent steps in FIG. 11 is used and a case where it is not used. The processing times are measured in a case where approximation is used as illustrated in FIG. 32A and a case where approximation is not used as illustrated in FIG. 32B.

The performance ratio is a ratio of the processing time in a case where reduction by max is not applied against the processing time in a case where reduction by max is applied. In other words, for example, the performance ratio indicates how many times the processing speed increases by applying reduction by max. When approximation is used, the processing speed increases by 3.4 to 9.5 times. This indicates that, as the number of vertices increases, the performance ratio increases. When approximation is not used, the processing speed increases by 8.0 to 12.2 times. This may indicate that, as the number of vertices increases, the performance ratio tends to increase though the processing speed decreases at some parts.

### Comparison with Extended. Dijkstra

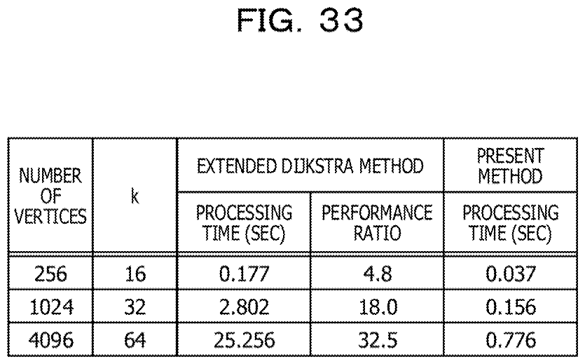

FIG. 33 is a diagram for explaining comparison with extended Dijkstra. The processing times with the method according to the aforementioned embodiment by approximation and with extended Dijkstra method are compared. The extended Dijkstra method used for the measurement has an improvement that the number of shortest paths to be acquired at an intermediate point is limited to k. FIG. 33 illustrates a summary of measurement results. The performance ratio indicates how many times the method according to the embodiment is faster than the extended Dijkstra method. The results illustrated in FIG. 33 indicate that the method according to the embodiment by approximation is faster than extended Dijkstra method by 4.8 to 32.5 times and that, as the number of vertices increases, the performance ratio increases.

### Comparisons Based on Method According to Embodiment

As illustrated in FIG. 29, the parameter a may be automatically adjusted to increase the processing speed as much as possible in a range equal to or higher than the precision required by a user, and adjustment of the parameter by a user may be omitted. As illustrated in FIG. 31, by using approximation, the processing speed may be increased by about 3 to 15 times while a precision of 1.0 is kept. The effectiveness of the increase of the speed increases as the number of vertices increases.

As illustrated in FIGS. 32A and 32B, because of reduction by max, the processing speed may be increased by about 3 to 10 times when approximation is used and by about 8 to 12 times when approximation is not used, The effectiveness of the effect mostly increases as the number of vertices increases. As illustrated in FIG. 33, the method according to the embodiment may increase the processing speed by about 5 to 33 times more than the extended Dijkstra method, and the effectiveness of the effect increases as the number of vertices increases.

### Embodiment 5

While an embodiment of the present disclosure has been described, the present disclosure may be implemented in various different forms other than the embodiment described above.

### Applied Graphs

A shortest path on an unweighted graph may be acquired at a high speed by using breadth-first search as known well. This may be easily implemented by using general “first-in, first-out” queues instead of priority queues. Even the method according to the embodiments may easily address unweighted graphs by replacing the priority queues by general queues. The method according to the embodiments may also address unweighted graphs by defining all weights as LO, but the processing speed is more increased by using breadth-first search.

Dijkstra method may address a directed graph. Therefore, the method according to the embodiments may be easily improved so as to address a directed graph. More specifically, when vertices v and w are adjacent to each other, data structures indicating edges are stored in adj_edge_list of v and w on an undirected graph. However, on a directed graph, an edge having a direction from v to w is only added to adj_edge_list of v. If the edge is bidirectional, it is also added to adj_edge_list of w. With these changes, the method according to the embodiments may address directed graphs.

### System

Processing procedures, control procedures, specific names, and information containing various kinds of data and parameters indicated in the specification and the drawings may be changed in any manner unless otherwise specified. The specific examples, distributions, numerical values, and so on described in the embodiments are merely examples and may be arbitrarily changed,

The constituent elements of the devices illustrated in the drawings are functional conceptual ones and not necessarily configured physically as illustrated in the drawings. Specific forms of distribution and integration of the devices are not limited to those illustrated in the drawings. All or some of the devices may be functionally or physically distributed or integrated in any unit based on various loads, usage statuses, or the like. All or some of the processing functions performed by the devices may be implemented by a central processing unit (CPU) and a program analyzed and run by the CPU or may be implemented by a hardware device using wired logic coupling.

### Hardware

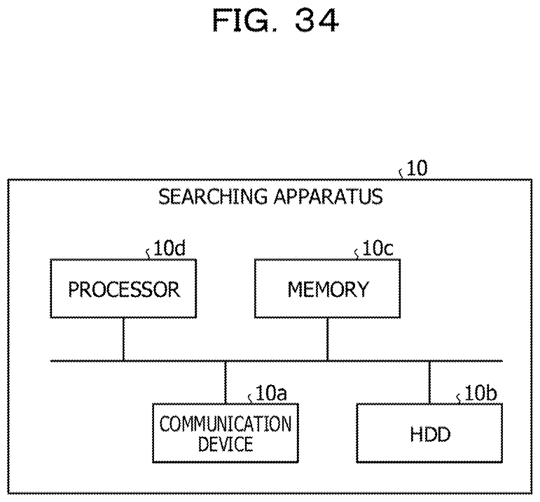

FIG. 34 is a diagram for explaining a hardware configuration example. As illustrated in FIG. 34, the searching apparatus 10 includes a communication device 10a, a hard disk drive (HOD) 10b, a memory 10c, and a processor 10d. The devices illustrated in FIG. 34 are coupled to each other via a bus or the like.

The communication device 10a is, for example, a network interface card and communicates with a server. The HDD 10b stores a program and DBs that implement functions illustrated in FIG. 2.

The processor 10d executes processes that implement the functions illustrated in, for example, FIG. 2 by reading from the HOD 10b or the like the program that implements processing operations identical to those of the processing units illustrated in FIG. 2 and loading the program into the memory 10c. In other words, for example, the processes implement the same functions as that of the processing units included in the searching apparatus 10. Specifically, the processor 10d reads out a program having the same functions as those of the initial setting unit 21, the searching unit 22, the output control unit 23, or the like from the HDD 10b and the like. The processor 10d executes processing of executing the same processing as those of the initial setting unit 21, the searching unit 22, the output control unit 23, or the like.

As described above, the searching apparatus 10 functions as an information processing apparatus that implements a searching method by reading and running the program. The searching apparatus 10 may also implement the same functions as those of the embodiments described above by reading the program from a recording medium with the use of a medium reading device and running the read program. The program described in other embodiments is not limited to a program that is run by the searching apparatus 10. For example, the disclosure is applicable to the case in which another computer or a server runs the program or the case in which the other computer and the server cooperate to run the program.

The program may be distributed via a network such as the Internet. The program may be recorded on a computer-readable recording medium such as a hard disk, a flexible disk (FD), a compact disc read-only memory (CD-ROM), a magneto-optical disk (MO), a digital versatile disc (DVD), or the like, and may be executed after being read from the recording medium by a computer.

All examples and conditional language provided herein are intended for the pedagogical purposes of aiding the reader in understanding the invention and the concepts contributed by the inventor to further the arcₛ and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A path searching method to be executed by a computer, the path search method comprising;
identifying a starting point and an end point from among a plurality of nodes included in graph data;
when a predetermined number of shortest paths are searched from among paths jointing the starting point and the end point, by using a limit value for which a value lower than the predetermined number is set, identifying a joint point where a path from the starting point and a path from the end point are jointed from both of the starting point and the end point;
limiting a number of paths to be held in association with each of the plurality of nodes including the joint point to a number equal to or lower than the limit value to hold one or more paths having a short distance from among paths reaching each of the plurality of nodes;
searching the predetermined number of shortest paths from among the paths reaching the joint point by using the one or more paths held in association with the plurality of nodes; and
outputting the searched predetermined number of shortest paths.

2. The path searching method according to claim 1, wherein
the limiting includes
holding paths reaching the nodes by using a priority queue; and
the searching includes
when a sum of a length from a departing point to a vertex and a shortest path length from the other departing point to the vertex or a length of the path at the beginning of the priority queue is equal to or longer than the longest one of the predetermined number of paths that have been searched, not extending a search range further from the vertex.

3. The path searching method according to claim 1,
wherein the searching includes
generating a plurality of paths by combining paths from the starting point to the joint point and paths from the end point to the joint point, sequentially identifying paths having shorter distances among the plurality of paths, and searching the predetermined number of shortest paths.

4. The path searching method according to claim 1,
wherein the holding includes
limiting the number of paths to be held in association with each of the plurality of nodes including the joint point to a number equal to or lower than a square root of the limit value.

5. The path searching method according to claim 4,
wherein the limiting includes
limiting the number of paths to be held in association with each of the plurality of nodes including the joint point to a number equal to or lower than a multiplication value acquired by multiplying the square root of the limit value by a fixed parameter.

6. The path searching method according to claim 5,
wherein the parameter is a maximum value that satisfies a precision designated by a user in a case where a path search simulation is performed by increasing a maximum number of paths from 1 to the limit value, wherein the maximum number of paths is a number of partial shortest paths from a departing point of the path search to a joint point.

7. A non-transitory computer-readable storage medium storing a program that causes a computer to execute a process, the process comprising:
identifying a starting point and an end point o a plurality of nodes included in graph data;
when a predetermined number of shortest paths having shorter distances are to be searched among paths jointing the starting point and the end point, by using a limit value for which a value lower than the predetermined number is set, identifying a joint point where a path from the starting point and a path from the end point are jointed from both of the starting point and the end point;
limiting a number of paths to be held in association with each of the plurality of nodes including the joint point to a number equal to or lower than the limit value to hold one or more paths having a short distance from among paths reaching each of the plurality of nodes;
searching the predetermined number of shortest paths from the paths reaching the joint point by using the one or more paths held in association with the plurality of nodes; and
outputting the searched predetermined number of shortest paths

8. A path searching apparatus, comprising:
a memory; and
a processor coupled to the memory and configured to:
identify a starting point and an end point from among a plurality of nodes included in graph data;
when a predetermined number of shortest paths are searched from among paths jointing the starting point and the end point, by using a limit value for which a value lower than the predetermined number is set, identify a joint point where a path from the starting point and a path from the end point are jointed from both of the starting point and the end point;
limit a number of paths to be held in association with each of the plurality of nodes including the joint point to a number equal to or lower than the limit value to hold one or more paths having a short distance from among paths reaching each of the plurality of nodes;
search the predetermined number of shortest paths from among the paths reaching the joint point by using the one or more paths held in association with the plurality of nodes; and
output the searched predetermined number of shortest paths.

9. The path searching apparatus according to claim 8, wherein the processor is configured to:
hold paths reaching the nodes by using a priority queue; and
when a sum of a length from a departing point to a vertex and a shortest path length from the other departing point to the vertex or a length of the path at the beginning of the priority queue is equal to or longer than the longest one of the predetermined number of paths that have been searched, not extend a search range further from the vertex.

10. The path searching apparatus according to claim 8, wherein the processor is configured to
generate a plurality of paths by combining paths from the starting point to the joint point and paths from the end point to the joint point, sequentially identifying paths having shorter distances among the plurality of paths, and searching the predetermined number of shortest paths.

11. The path searching apparatus according to claim wherein the processor is configured to
limit the number of paths to be held in association with each of the plurality of nodes including the joint point to a number equal to or lower than a square root of the limit value.

12. The path searching apparatus according to claim 11, wherein the processor is configured to
limit the number of paths to be held in association with each of the plurality of nodes including the joint point to a number equal to or lower than a multiplication value acquired by multiplying the square root of the limit value by a fixed parameter.

13. The path searching apparatus according to claim 12,
wherein the parameter is a maximum value that satisfies a precision designated by a user when a path search simulation is performed by increasing a maximum number of paths from 1 to the limit value, wherein the maximum number of paths is a number of partial shortest paths from a departing point of the path search to a joint point.
